(19) United States
(12) Patent Application Publication
(10) Pub. No.: US 2017/0324669 A1
(43) Pub. Date: Nov. 9, 2017

(54) CONTROL APPARATUS, DATA TRANSMITTING SYSTEM, AND METHOD OF DATA TRANSMITTING

(71) Applicant: FUJITSU LIMITED, Kawasaki-shi (JP)

(72) Inventor: Keiichi Nakatsugawa, Shinagawa (JP)

(73) Assignee: FUJITSU LIMITED, Kawasaki-shi (JP)

(21) Appl. No.: 15/492,257

(22) Filed: Apr. 20, 2017

(30) Foreign Application Priority Data
May 6, 2016 (JP) 2016-093057

(51) Int. Cl. H04L 12/825; H04L 12/863; H04L 12/26

(52) U.S. Cl. CPC H04L 47/25; H04L 43/0894; H04L 47/50

(57) ABSTRACT

A control apparatus controlling a first data transfer apparatus including a first port, the control apparatus includes a memory, and a processor configured to detect a first transmission rate of first data transmitted using the first port is equal to or higher than a first value, when it is detected that the first transmission rate is equal to or higher than the first value, request the first data transfer apparatus to change a destination of a first packet from a first information processing apparatus to a data buffer, after the first packet transmitted from the first data transfer apparatus is stored for a first period in the data buffer, cause the data buffer to transmit the first packet to the first data transfer apparatus, and request the first data transfer apparatus to change the destination of the first packet from the data buffer apparatus to the first information processing apparatus.

### CROSS-REFERENCE TO RELATED APPLICATION

This application is based upon and claims the benefit of priority of the prior Japanese Patent Application No. 2016-093057, filed on May 6, 2016, the entire contents of which are incorporated herein by reference.

### FIELD

The embodiments relate to a control apparatus, a data transmitting system, and a method of data transmitting.

### BACKGROUND

In recent years, attention is paid to OpenFlow as a technology that allows flexible packet transfer control. In OpenFlow, a combination of a Match condition for identifying a flow of a control target and an Instruction is notified of from an OpenFlow Controller (OFC) to an OpenFlow Switch (OFS). The Instruction represents a process to be executed by the OFS for a packet of a flow that satisfies the associated Match condition. For example, as the Instruction, transfer, discarding, rewriting of a field in the header and so forth of a packet that satisfies the Match condition may be designated. Combinations of Match conditions and Instructions are stored as a flow table in the OFS. A combination of a Match Condition and an Instruction may be designed freely by an operation manager or a user of the network. Further, a notification of the set combination is notified of from the OFC to the OFS using the OpenFlow protocol, and the set combination is updated in response to the notification from the OFC by the OFS. Therefore, the operation manager or the use of the network may dynamically and programmably set the flow table to be used for determination of contents of process by the OFS.

Also in a system that uses OpenFlow, a connection type protocol or a connectionless protocol is sometimes used for communication similarly as in other systems. In communication that uses a connection, congestion control is performed because the available transmission rate is fluctuated by a congestion of the network and so forth. For example, in the transmission control protocol (TCP), a process called slow start is performed in order to adjust the transmission amount of packets using a congestion window. In the slow start, after an apparatus on the transmission side starts communication with an apparatus of the destination, it increments the value in the congestion window every time an acknowledge response packet is received to increase the transmission rate until detecting packet loss. If packet loss occurs, the communication apparatus on the transmission side decreases the transmission rate and decreases also the variation amount of the transmission rate upon later adjustment.

As a related art, a central controller is proposed which determines a suppression rate using the weight of a traffic group passing a link in congestion and a traffic rate at present, and the traffic rate obtained in this manner is transmitted to a switch. Also a communication apparatus is proposed which has stored therein a control condition based on statistical values of a result of processing of reception packets in advance and the packet transfer rate may be controlled based on a measured statistical value and the control condition. Furthermore, a control apparatus is proposed wherein an inflow traffic amount to a path whose start point is a communication apparatus is collected in a given period and an inflow traffic amount in the following and later periods is predicted and then a rate limit is adjusted in response to the value of the predictive traffic amount. As prior art documents, there are Japanese National Publication of International Patent Application No. 2015-519823, Japanese Laid-open Patent Publication No. 2014-27696, Japanese Laid-open Patent Publication No. 2014-147014, and “OpenFlow Switch Specification Version 1.5.1.”

### SUMMARY

According to an aspect of the embodiments, a control apparatus configured to control a first data transfer apparatus including a first port, the control apparatus includes a memory, and a processor coupled to the memory and configured to detect that a first transmission rate of first data transmitted using the first port of the first data transfer apparatus is equal to or higher than a first value, request, when it is detected that the first transmission rate is equal to or higher than the first value, the first data transfer apparatus to change a destination of a first packet from a first information processing apparatus to a data buffer, the first packet being to be transmitted using the first port, cause, after the first packet transmitted from the first data transfer apparatus is stored in the data buffer for a first period, the data buffer to transmit the first packet to the first data transfer apparatus, and request the first data transfer apparatus to change the destination of the first packet from the data buffer to the first information processing apparatus, the first packet being transmitted from the data buffer to the first data transfer apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic view illustrating an example of a communication method according to an embodiment;

FIG. 2 is a block diagram depicting an example of a configuration of a control apparatus;

FIG. 3 is a block diagram depicting an example of a hardware configuration of a control apparatus;

FIG. 4 is a view illustrating an example of topology information of a system;

FIG. 5 is a view illustrating an example of transfer apparatus information;

FIG. 6 is a view illustrating an example of flow information notified of from a transfer apparatus;

FIG. 7 is a view illustrating an example of information retained by a control apparatus;

FIG. 8 is a schematic view illustrating an example of a communication method;

FIG. 9 is a view illustrating an example of an updating process for a flow table;

FIG. 10 is a schematic view illustrating an example of a communication method;

FIG. 11 is a flow chart illustrating a decision process for a start and a stop of rate control;

FIG. 12 is a flow chart illustrating an example of a setting process for rate control;

FIG. 13 is a flow chart illustrating an example of details of rate control;

FIGS. 14A, 14B and 14C are view illustrating examples of a time variation of throughput;

FIG. 15 is a view illustrating an example of a flow table used in a second embodiment;

FIG. 16 is a schematic view illustrating an example of a communication method;

FIG. 17 is a view illustrating an example of updating of a flow table;

FIG. 18 is a view illustrating an example of control target information;

FIG. 19 is a flow chart illustrating an example of a setting process performed in the second embodiment;

FIG. 20 is a schematic view illustrating an example of a communication process performed in a third embodiment;

FIG. 21 is a view illustrating an example of a flow table used in the third embodiment;

FIG. 22 is a schematic view illustrating an example of a communication process performed in a fourth embodiment;

FIG. 23 is a view illustrating an example of a flow table used in the fourth embodiment;

FIG. 24 is a flow chart illustrating an example of a process performed in the fourth embodiment;

FIG. 25 is a view illustrating an example of updating of a flow table;

FIG. 26 is a schematic view illustrating an example of a communication process performed in a fifth embodiment;

FIG. 27 is a view illustrating an example of transfer apparatus information;

FIG. 28 is a schematic view illustrating an example of a communication process performed in a sixth embodiment;

FIG. 29 is a view illustrating an example of information retained in a control apparatus;

FIG. 30 is a flow chart illustrating an example of a process performed in the sixth embodiment;

FIG. 31 is a schematic view illustrating an example of a communication process performed in a seventh embodiment;

FIG. 32 is a view illustrating an example of a flow table;

FIG. 33 is a flow chart illustrating an example of a process performed in the seventh embodiment;

FIG. 34 is a view illustrating an example of an updating process for a flow table;

FIG. 35 is a flow chart illustrating an example of a process performed by a control apparatus;

FIG. 36 is a diagrammatic view depicting an example of a system to which an eighth embodiment is applied;

FIG. 37 is a schematic view illustrating an example of a communication process performed in the eighth embodiment;

FIG. 38 is a view illustrating an example of a flow table;

FIG. 39 is a view illustrating an example of control target information; and

FIG. 40 is a flow chart illustrating an example of a setting process performed in the eighth embodiment.

### DESCRIPTION OF EMBODIMENTS

If discarding of a packet occurs in communication for which congestion control is performed, the transmission rate decreases suddenly, resulting in sudden drop of the transfer speed. Further, after the transmission rate drops, also the changing amount of the transmission rate upon adjustment of the transmission rate becomes smaller than that before occurrence of discarding of a packet. Therefore, a period of time within which a transmission rate lower than an actually applicable transmission rate is applied becomes long and the communication efficiency degrades. Such a situation may possibly occur in arbitrary communication in which the transmission rate is controlled.

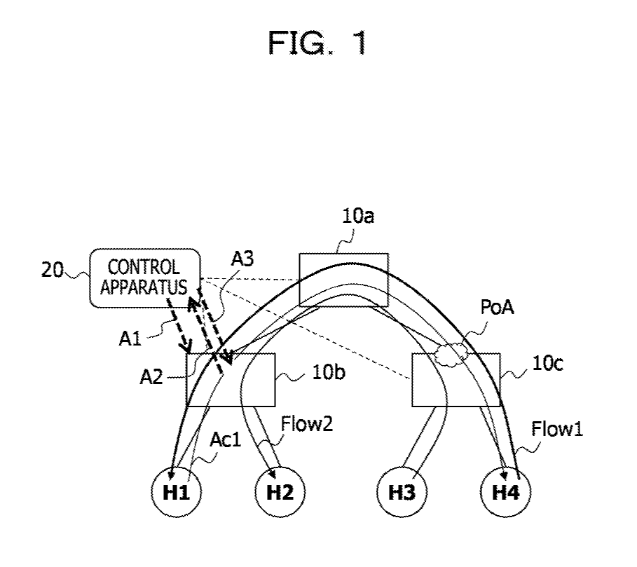

FIG. 1 is a schematic view illustrating an example of a communication method according to an embodiment. In the following description, it is assumed that a control apparatus 20 controls process in a transfer apparatus 10 and the transfer apparatus 10 processes a packet to be transmitted and received between hosts in accordance with a process rule notified of to the transfer apparatus 10 from the control apparatus 20. The control apparatus 20 is implemented, for example, as an OFC. The transfer apparatus 10 is implemented, for example, as an OFS. The system depicted in FIG. 1 includes hosts H1 to H4, transfer apparatus 10 (10a to 10c), and a control apparatus 20. In FIG. 1, a link indicated by a solid line is used for transmission and reception of a packet in a data plane, and a link indicated by a broken line is used for transmission and reception of a packet in a control plane.

The transfer apparatus 10a is coupled to the transfer apparatus 10b and the transfer apparatus 10c. The host H1 and the host H2 are coupled to the transfer apparatus 10b. The host H3 and the host H4 are coupled to the transfer apparatus 10c. In FIG. 1, it is assumed that communication between the host H4 and the host H1 and communication between the host H3 and the host H4 occur. A flow of a TCP packet transmitted from the host H4 to the host H1 is represented as Flow1. Meanwhile, a flow of an acknowledge response packet (Ack packet) to a packet in the flow Flow1 is represented as Ac1. Further, a flow of a packet transmitted from the host H3 to the host H2 is represented as Flow2. Respective routes of the flows are determined by the control apparatus 20. In the example of FIG. 1, a packet in the flow Flow1 is transferred from the host H4 to the transfer apparatus 10c, the transfer apparatus 10a, and the transfer apparatus 10b in order and is further transferred from the transfer apparatus 10b to the host H1. Meanwhile, a packet in the flow indicated by Ac1 is transferred from the host H1 to the transfer apparatus 10b, the transfer apparatus 10a, and the transfer apparatus 10c in order and then is transferred from the transfer apparatus 10c to the host H4. A packet included in the flow Flow2 is transferred from the host H3 to the transfer apparatus 10c, the transfer apparatus 10a, and the transfer apparatus 10b in order and then is transferred to the host H2.

The control apparatus 20 periodically acquires, from each transfer apparatus 10, a control packet that reports a communication situation of each of ports provided on the transfer apparatus 10 and information of a flow to be transferred from each port. It is assumed that, in FIG. 1, the load on the port PoA of the transfer apparatus 10c exceeds a given threshold value. In the following description, a state in which a process load to a certain port exceeds a threshold value is sometimes referred to as the port is congesting.

If the control apparatus 20 detects occurrence of congestion, the control apparatus 20 determines at least part of packets in the flow to be transferred through the port with which the congestion occurs as a packet or packets of a control target (target packet) for rate control. The control apparatus 20 requests at least one of the transfer apparatus 10, which are processing the target packet, to transfer the target packet to the control apparatus 20. In the example of FIG. 1, the control apparatus 20 determines a packet included in the flow Ac1 from among the respective flows Flow1, Flow2, and Ac1 transferred through the port PoA in the transfer apparatus 10c as a target packet. Further, since the transfer apparatus 10b processes a packet (target packet) in the flow Ac1, the control apparatus 20 notifies the transfer apparatus 10b to transfer a target packet to the control apparatus 20 as a process rule to be applied in the transfer apparatus 10b (arrow mark A1).

When the transfer apparatus 10b receives the new process rule from the control apparatus 20, the transfer apparatus 10b updates the flow table using the process rule. Thereafter, if a packet in the flow Ac1 is received, the transfer apparatus 10b transfers the received packet to the control apparatus 20 in accordance with the updated flow table (arrow mark A2). At this time, the transfer apparatus 10b transfers the packet in the flow Ac1 to the control apparatus 20, for example, using a Packet-In message of OpenFlow.

When the target packet is received, the control apparatus 20 retains the received target packet for a given period of time and then transfers the target packet toward the transfer source such that the target packet is transferred from the transfer source toward the destination. For example, after the packet in the flow Ac1 is retained for the given period of time, the control apparatus 20 outputs the packet to the transfer apparatus 10b that is the transfer source of the packet in the flow Ac1. At this time, the control apparatus 20 outputs the packet to the transfer apparatus 10b together with information that designates an output port of the transfer apparatus 10b such that the packet to be outputted is to be transferred to the destination (arrow mark A3). For example, the control apparatus 20 may use a Packet-Out message of OpenFlow or the like. For example, a Packet-Out message including the packet in the flow Ac1 transferred to the control apparatus 20 by the Packet-In message and information designating a port coupled to the transfer apparatus 10a from among the ports of the transfer apparatus 10b as the output destination may be used along the arrow mark A3.

When the target packet is received together with the information of the output port from the control apparatus 20, the transfer apparatus 10b outputs the target packet to the output port. Therefore, the target packet arrives from the transfer apparatus 10b at the host H4 through the transfer apparatus 10a and the transfer apparatus 10c as indicated by the arrow mark Ac1 in FIG. 1. Accordingly, the time at which the target packet arrives at the destination is delayed by a period of time that is the sum of a period of time for which the target packet is retained in the control apparatus 20 and a period of time for a reciprocating movement of the target packet between the transfer apparatus 10b and the control apparatus 20.

A communication apparatus that transmits data using the TCP protocol transmits succeeding data in response to reception of an acknowledge response in order to suppress occurrence of an overflow at a buffer held by an apparatus of the destination of the data. In the example of FIG. 1, the host H4 transmits data packets of an amount that does not exceed the buffer amount of the host H1. Then, if the host H4 receives an acknowledge response packet from the host H1, the host H4 further transmits data packets to the host H1. If the acknowledge response packet is delayed by the processes of the arrow marks A1 to A3 in FIG. 1, the host H4 decides that a delay occurs with the process in the host H1, and decreases the transfer rate of the flow Flow1 in order to decrease the transmission rate of data packets. Accordingly, the congestion state at the port PoA of the transfer apparatus 10c disappears.

It is to be noted that, while the example of FIG. 1 is directed to a case in which a packet in the flow Ac1 is made a target packet as a target of a delay process, a data packet may be made a target of a delay process. Also in this case, since a data packet is transferred to the control apparatus 20, the period of time for a flow of a data packet arriving from the transmission source at the destination increases. Since the delay of the data packet increases also the period of time until the transmission source acquires an Ack packet, the transfer rate drops, and as a result, the congestion disappears.

<Apparatus Configuration>

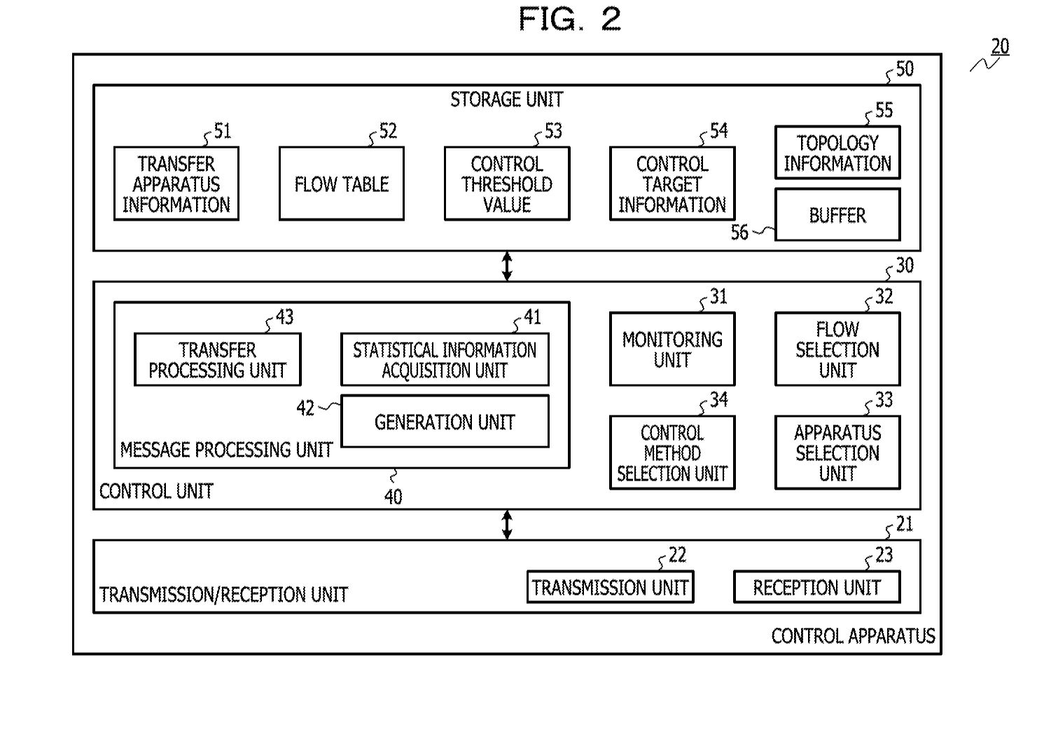

FIG. 2 is a view depicting an example of a configuration of the control apparatus 20. The control apparatus 20 includes a transmission/reception unit 21, a control unit 30, and a storage unit 50. The transmission/reception unit 21 includes a transmission unit 22 and a reception unit 23. The control unit 30 includes a monitoring unit 31 and a message processing unit 40. The control unit 30 may include a flow selection unit 32, an apparatus selection unit 33, and a control method selection unit 34 as optional components. The storage unit 50 retains transfer apparatus information 51, a flow table 52, a control threshold value 53, control target information 54, and topology information 55 and further operates as a buffer 56.

The transfer apparatus information 51 is information of the transfer apparatus 10 controlled by the control apparatus 20. The flow table 52 is information that associates a process rule notified of to each transfer apparatus 10 from the control apparatus 20 with a flow that is an application target of the process rule. It is to be noted that each transfer apparatus 10 has stored in each transfer apparatus 10 a combination of a process rule notified of from the control apparatus 20 and information of a flow to which the process rule is applied as a flow table of the individual transfer apparatus 10, and performs process in accordance with the flow table. Therefore, the flow table 52 may be considered as information that summarizes information of settings of processes for packets by each transfer apparatus 10. Further, the flow table 52 may additionally have stored information collected from the transfer apparatus 10 by the control apparatus 20.

The control threshold value 53 is a threshold value to be used to determine a start and an end of control by the control apparatus 20. Here, the control threshold value 53 is set such that, even if rate control is started after the use rate of any port of the transfer apparatus 10 in the system reaches the control threshold value 53, packet discarding does not occur. For example, since there is the possibility that, even if rate control is started, the transfer rate may not decrease for some period of time, the control threshold value 53 is set such that, even within a period after rate control is started until the transfer rate begins to decrease, the use rate becomes lower than the use rate when packet discarding occurs. The control target information 54 is information of a target flow that is a target of control of the transfer rate by the control apparatus 20. The topology information 55 is information relating to a coupling or an address of the transfer apparatus 10 of a control target of the control apparatus 20 or a host coupled to the transfer apparatus 10 of the control target. Examples of the transfer apparatus information 51, the flow table 52, the control target information 54, the topology information 55 and so forth are hereinafter described. The buffer 56 is suitably used for retention of data or a packet.

The transmission unit 22 transmits a packet to a different apparatus such as a transfer apparatus 10. The reception unit 23 receives a packet from a different apparatus such as a transfer apparatus 10. The monitoring unit 31 compares the use rate of each port determined from the transfer rate at the port provided for each transfer apparatus 10 with the control threshold value 53 to determine a start or an end of control of the transfer rate.

The flow selection unit 32 selects a flow that makes a target of transfer rate control. The apparatus selection unit 33 selects a transfer apparatus 10 from which a target packet is to be transferred to the control apparatus 20 in order to perform control of the transfer rate. The control method selection unit 34 selects a control method for controlling the transfer rate. Details of the processes mentioned are hereinafter described.

A statistical information acquisition unit 41 acquires, from a control packet acquired from a transfer apparatus 10, information of the ports provided on the transfer apparatus 10 of the transfer source of the control packet or statistical information of a flow. A generation unit 42 generates a message for notifying a transfer apparatus 10 of a process rule. For the notification of a process rule, for example, a FlowMod message or the like may be used. A transfer processing unit 43 generates a control packet for transferring a target packet after retained for a given period of time by the buffer 56 to the transfer source of the target packet. Here, the control packet includes also a designation of an output port for the target packet of the transfer apparatus 10 of the destination. For example, the transfer processing unit 43 may notify the transfer source of the target packet of the target packet and designation information of an output port for the target packet using a Packet-out message.

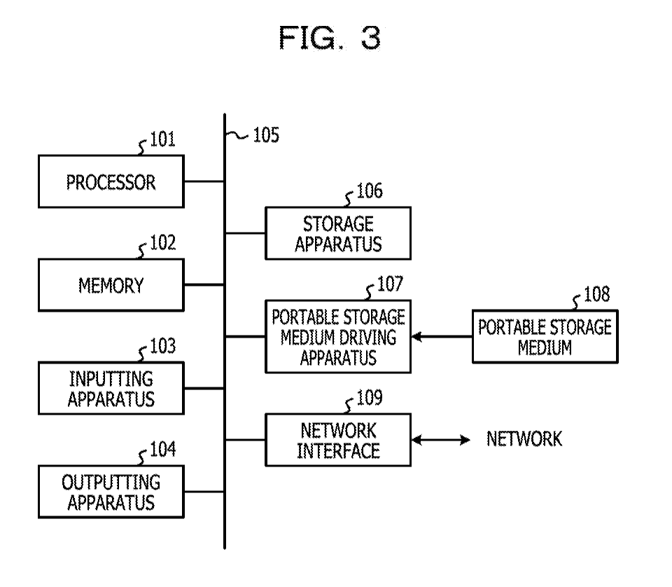

FIG. 3 is a view depicting a hardware configuration of the control apparatus. The control apparatus 20 includes a processor 101, a memory 102, a bus 105, and a network interface 109. The control apparatus 20 may further include one or more of an inputting apparatus 103, an outputting apparatus 104, a storage apparatus 106, and a portable storage device driving apparatus 107. The processor 101 is an arbitrary process circuit including a central processing unit (CPU) and may execute a program stored in the memory 102 or the storage apparatus 106. The memory 102 may be used as a working memory or a buffer of the processor 101. As the memory 102, a semiconductor memory such as a random access memory (RAM) may be used. The bus 105 couples the processor 101, the memory 102, and the network interface 109 for transmission and reception of data to each other. The network interface 109 performs inputting and outputting of information to and from the network. The network interface 109 is configured using a network interface card (NIC), a wireless local area network (LAN) card or the like.

The inputting apparatus 103 is an arbitrary apparatus used to input information such as a keyboard. The outputting apparatus 104 is an arbitrary apparatus used to output data such as a display unit. The portable storage device driving apparatus 107 may output data of the memory 102 or the storage apparatus 106 to a portable storage device 108. Further, the portable storage device driving apparatus 107 may read out a program, data or the like from the portable storage device 108. Here, the portable storage device 108 is an arbitrary storage medium capable of being carried. For example, the portable storage device 108 includes a secure digital (SD) card, a mini SD card, a micro SD card, a universal serial bus (USB) flash memory, a compact disc (CD), a digital versatile disc (DVD), a Blu-ray (registered trademark) disc, a flash memory card and so forth. Meanwhile, as the storage apparatus 106, a nonvolatile memory such as an erasable programmable read-only memory (EPROM) or a hard disk drive may be used.

In the control apparatus 20, the control unit 30 is implemented by the processor 101, and the storage unit 50 is implemented by the memory 102 and the storage apparatus 106. Further, the network interface 109 and the processor 101 operate as the transmission/reception unit 21.

It is to be noted that also the transfer apparatus 10 includes the hardware configuration depicted in FIG. 3. In each transfer apparatus 10, the network interface 109 is used for communication with a different transfer apparatus 10 or the control apparatus 20. Further, the transfer apparatus 10 stores information notified of from the control apparatus 20 into the memory 102 or the storage apparatus 106. The processor 101 provided in the transfer apparatus 10 performs process using information stored in the memory 102 or the storage apparatus 106.

### First Embodiment

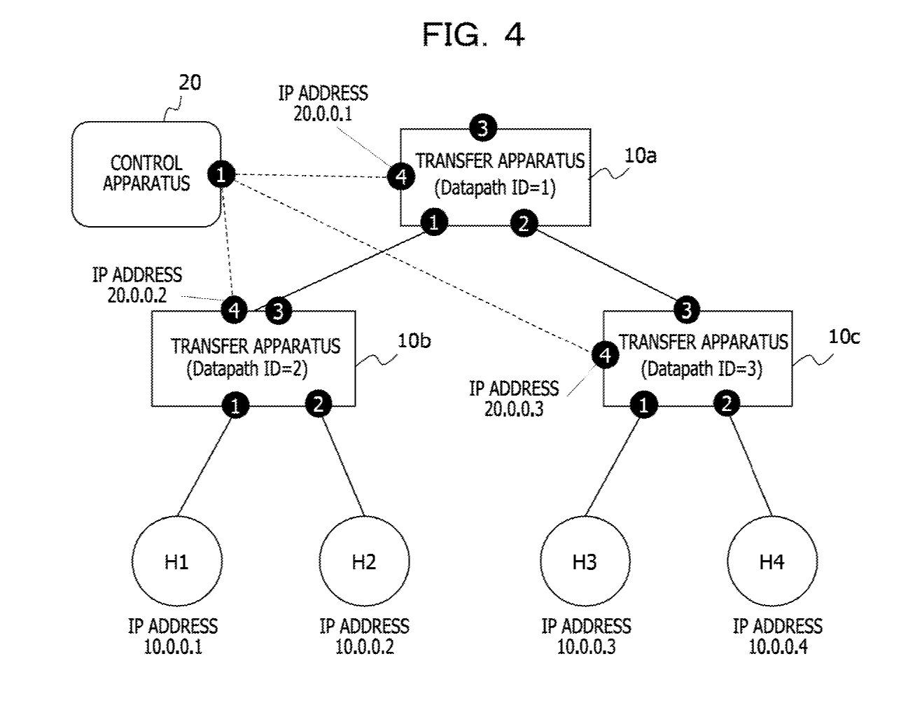

FIG. 4 is a view illustrating an example of the topology information 55 of the system. In FIG. 4, in order to facilitate understandings, the topology information 55 is illustrated as a view illustrating a coupling scheme to the transfer apparatus 10 and the control apparatus 20. However, the control apparatus 20 may retain the topology information 55 in an arbitrary form. In FIG. 4, each port of the transfer apparatus 10 is indicated by a dark round mark, and a port number is indicated in the dark round mark. The control apparatus 20 identifies each transfer apparatus 10 in the system depending upon a data path identifier (ID). In FIG. 4, the data path ID of the transfer apparatus 10a is 1; the data path ID of the transfer apparatus 10b is 2; and the data path ID of the transfer apparatus 10c is 3.

In the transfer apparatus 10c, the port 1 is coupled to the host H3, and the port 2 is coupled to the host H4. Further, the port 3 of the transfer apparatus 10c is coupled to the port 2 of the transfer apparatus 10a, and the port 4 of the transfer apparatus 10c is coupled to the control apparatus 20. The port 1 of the transfer apparatus 10a is coupled to the port 3 of the transfer apparatus 10b, and the port 4 of the transfer apparatus 10a is coupled to the control apparatus 20. In the transfer apparatus 10b, the port 1 is coupled to the host H1, and the port 2 is coupled to the host H2. Furthermore, the port 4 of the transfer apparatus 10b is coupled to the control apparatus 20. In FIG. 4, a link used for transmission and reception of a control packet is indicated by a broken line, and a link used for transmission and reception of a data packet, an Ack packet or the like is indicated by a solid line.

The topology information 55 includes also information of an address allocated to each apparatus. In the example of FIG. 4, the internet protocol (IP) address allocated to the host H1 is 10.0.0.1. Meanwhile, to the host H2, the host H3, and the host H4, 10.0.0.2, 10.0.0.3, and 10.0.0.4 are allocated, respectively. To those of the ports provided on each transfer apparatus 10 which are used for communication with the control apparatus 20, IP addresses are set. For example, to the port 4 of the transfer apparatus 10a, the IP address of 20.0.0.1 is allocated. Similarly, to the port 4 of the transfer apparatus 10b, 20.0.0.2 is allocated, and to the port 4 of the transfer apparatus 10c, 20.0.0.3 is allocated.

The statistical information acquisition unit 41 of the control apparatus 20 periodically inquires a transfer apparatus 10, whose coupling to the control apparatus 20 is recorded in the topology information 55, about operation information of the each ports provided on the transfer apparatus 10 and information of flows transmitted and received through the each ports. At this time, the statistical information acquisition unit 41 generates a requesting message for statistical information to each of the transfer apparatus 10 of an inquiry destination and transmits the generated message through the transmission unit 22. For example, as the requesting message for statistical information, an OFPMP_PORT_STATS request, an OFPMP_FLOW_STATS request, an OFPMP_AGGREGATE_STATS request and so forth may be used.

The transfer apparatus 10 that receives the request message for statistical information transmits a response message including statistical information to the control apparatus 20. As the response message, such messages as an OFPMP_PORT_STATS reply, an OFPMP_FLOW_STATS reply, an OFPMP_AGGREGATE_STATS reply and so forth may be used. When the statistical information acquisition unit 41 in the control apparatus 20 acquires the response message through the reception unit 23, the statistical information acquisition unit 41 updates the transfer apparatus information 51 with the obtained information.

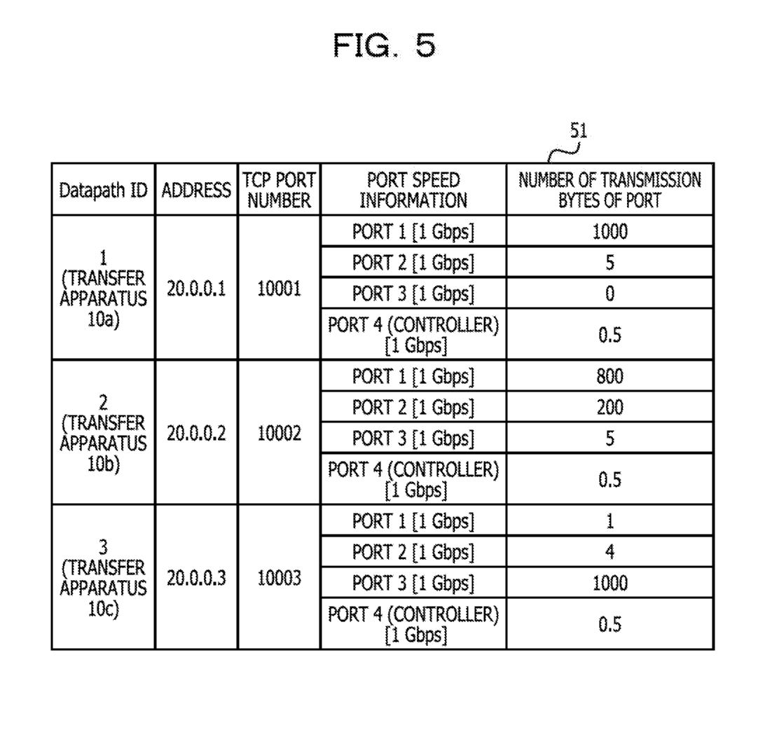

FIG. 5 is a view illustrating an example of the transfer apparatus information 51. The transfer apparatus information 51 includes a data path ID, an address, a TCP port number, port speed information, and the number of transmission bytes of a port. In the field of the address, a transmission source IP address of a control packet received from a transfer apparatus 10 identified by the data path ID by the control apparatus 20 is stored. The TCP port number is a transmission source port number of a control packet received by the control apparatus 20 from the transfer apparatus 10 identified by the data path ID. The port speed information records a combination of a port number of each of the ports provided on the transfer apparatus 10 identified by the data path ID and a maximum value of the transfer speed at the port. The speed at each port is included in information notified of by handshake when each transfer apparatus 10 establishes a coupling to the control apparatus 20. For example, where OpenFlow is used, the control apparatus 20 may acquire information of the speed at each port from port description information included in an OFPT_FEATURES reply transmitted from the transfer apparatus 10. In regard to a port used in communication with the control apparatus 20, information (CONTROLLER) indicating that the coupling destination is the control apparatus 20 is recorded in the field for port speed information. The number of transmission bytes of a port is an accumulated value of the number of bytes transmitted through the port corresponding to the entry.

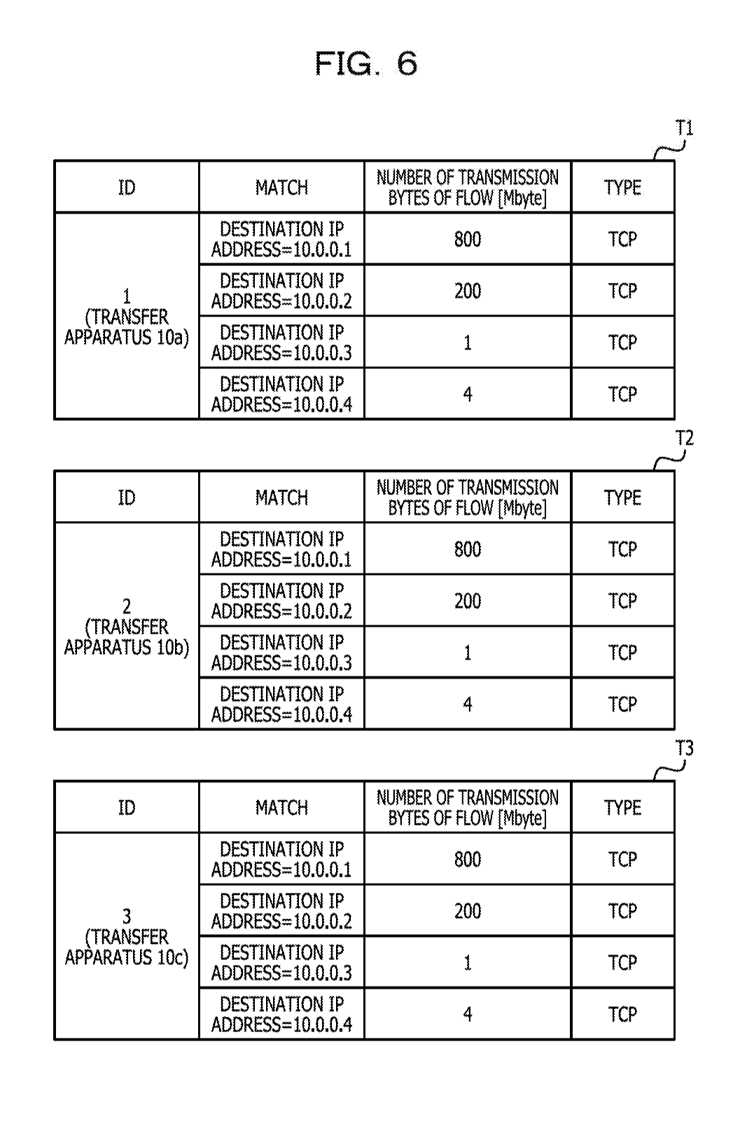

FIG. 6 is a view illustrating an example of flow information notified of from the transfer apparatus 10. From each transfer apparatus 10, an accumulated value of the number of transmission bytes for each flow and a type of the protocol used for transmission and reception of the flow are notified of in an associated relationship with the data path ID. Further, each flow is specified using a condition (Match condition) used for determination of a process rule.

A table T1 is an example of flow information to be notified of from the transfer apparatus 10a to the control apparatus 20. In the example of the table T1, packets of the destination IP address=10.0.0.1 (host H1) are classified as one flow. The transfer apparatus 10a notifies that a flow whose destination IP address=10.0.0.1 is transmitted by the TCP and the accumulated value of the number of transmission bytes is 800 Mbytes. Further, the transfer apparatus 10a notifies that a flow whose destination IP address=10.0.0.2 (host H2) is transmitted by the TCP and the accumulated value of the number of transmission bytes is 200 Mbytes. Furthermore, the accumulated value of the number of transmission bytes in the flow whose destination IP address=10.0.0.3 (host H3) is 1 Mbytes and the accumulated value of the number of transmission bytes in the flow whose destination IP address=10.0.0.4 (host H4) is 4 Mbytes. Also the flow destined for the destination IP address=10.0.0.3 and the flow destined for the destination IP address=10.0.0.4 are transmitted and received by the TCP.

Also any other transfer apparatus 10 notifies the control apparatus 20 of flow information similarly to the transfer apparatus 10a. In the example of FIG. 6, the transfer apparatus 10b transmits information of a table T2 to the control apparatus 20, and the transfer apparatus 10c transmits information of a table T3 to the control apparatus 20. It is to be noted that, although, in the example of FIG. 6, the flow information of which the transfer apparatus 10a to 10c notify is the same information, depending upon the transfer route of a flow, the flow information to be notified of to the control apparatus 20 may be different between different ones of the transfer apparatus 10.

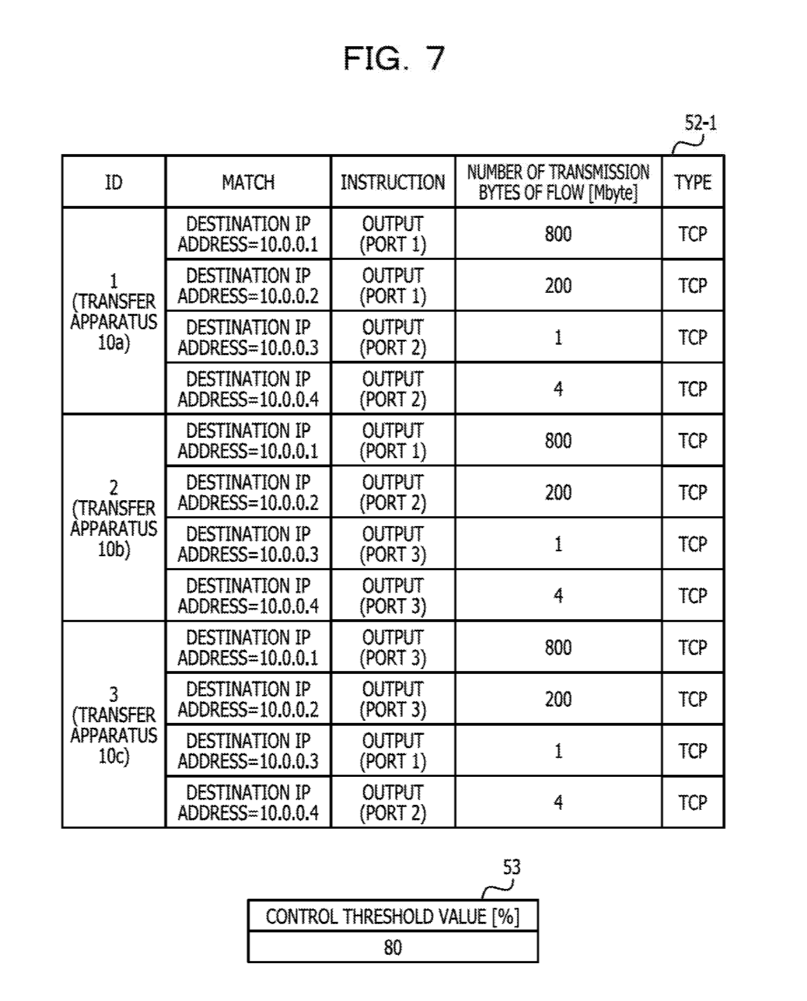

FIG. 7 is a view illustrating an example of information retained by the control apparatus 20. In the following description, in order to describe a manner in which the flow table 52 or the like is updated, a combination of a hyphen and a numerical value is sometimes included in a reference character. The flow table 52-1 stores a combination of a process rule of which each transfer apparatus 10 is notified from the control apparatus 20 and a Match condition used for specification of a flow to which the process rule is to be applied in an associated relationship with a transfer apparatus 10 of the notification destination. Further, also information of a flow specified by a Match condition in an entry from within flow information notified of from each transfer apparatus 10 is associated in the flow table 52.

For example, according to the process rule applied to the transfer apparatus 10a, a flow whose Match condition is the destination IP address=10.0.0.1 is outputted from the port 1. Further, since information described in the table T1 in FIG. 6 is notified of from the transfer apparatus 10a, also information that the number of transmission bytes of a flow of the destination IP address=10.0.0.1 is 800 Mbytes and the protocol type is the TCP is included in the flow table 52-1. Further, in the transfer apparatus 10a, a flow of the destination IP address=10.0.0.2 is outputted from the port 1, and a flow of the destination IP address=10.0.0.3 or the destination IP address=10.0.0.4 is outputted from the port 2. Also with the flows mentioned, the information notified of by the table T1 in FIG. 6 is associated.

Similarly, in the transfer apparatus 10b, a flow whose destination IP address=10.0.0.1 is outputted from the port 1, and a flow whose destination IP address=10.0.0.2 is outputted from the port 2. Further, in the transfer apparatus 10b, a flow whose destination IP address=10.0.0.3 or destination IP address=10.0.0.4 is outputted from the port 3. In the transfer apparatus 10c, while a flow whose destination IP address=10.0.0.1 or destination IP address=10.0.0.2 is outputted from the port 3, a flow whose destination IP address=10.0.0.3 is outputted from the port 1. Further, in the transfer apparatus 10c, a flow whose destination IP address=10.0.0.4 is outputted from the port 2. Further, in the flow table 52-1, information of the table T2 in FIG. 6 is associated with a flow to be transmitted and received through the transfer apparatus 10b, and information of the table T3 in FIG. 6 is associated with a flow to be transmitted and received through the transfer apparatus 10c.

In addition to the flow table 52, the control apparatus 20 retains the control threshold value 53. The statistical information acquisition unit 41 determines a transmission rate at each port using operation information of the ports. If the ratio at which the transmission rate occupies in a maximum value of the transfer speed at the port exceeds the control threshold value 53, the monitoring unit 31 decides that the load upon some port is high, and the control apparatus 20 starts control.

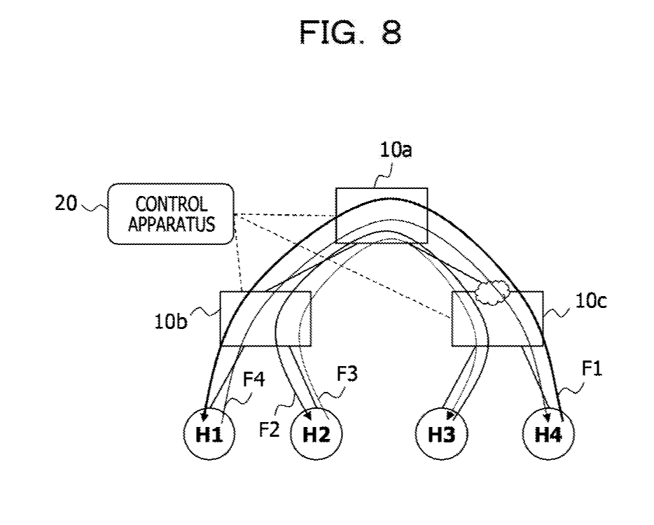

FIG. 8 is a view illustrating an example of a communication method according to the first embodiment. The statistical information acquisition unit 41 analyzes a transfer route of each flow or an operation state of the ports during communication or the like using information obtained from each transfer apparatus 10, the topology information 55, and the flow table 52.

FIG. 8 depicts a transfer route of a flow obtained when the topology of the network is such as illustrated in FIG. 4 and the information notified of from each transfer apparatus 10 to the control apparatus 20 is such as illustrated in FIGS. 5 and 6, and besides the control apparatus 20 retains the flow table 52-1. A flow F1 is a transfer route of a flow whose destination IP address=10.0.0.1. Similarly, a flow F2 is a transfer route of a flow whose destination IP address=10.0.0.2; a flow F3 is a transfer route of a flow whose destination IP address=10.0.0.3; and a flow F4 is a transfer route of a flow whose destination IP address=10.0.0.4.

The statistical information acquisition unit 41 further calculates the transfer speed at each of the ports of each of the transfer apparatus 10 using the number of transmission bytes obtained at the port upon collection in the preceding cycle and the number of transmission bytes obtained from the latest control packet. For example, it is assumed that the statistical information acquisition unit 41 receives a control packet in a period of 10 seconds from each transfer apparatus 10. Further, it is assumed that the number of transmission bytes 10 seconds ago was zero at all ports. If it is assumed that the transfer apparatus information 51 is updated as depicted in FIG. 5 with the latest control packet, the statistical information acquisition unit 41 converts the number of transmission bytes at each port into a bit number and divides the bit number by an acquisition interval of the control packets to determine a transfer rate (bps). For example, since the number of transmission bytes at the port 3 of the transfer apparatus 10c (data path ID=3) is 1000 Mbytes, the transfer rate is 1000 M×8÷10=800 Mbps. The statistical information acquisition unit 41 outputs the obtained transfer rate to the monitoring unit 31.

The monitoring unit 31 calculates a ratio of the transfer rate notified of from the statistical information acquisition unit 41 to the maximum value of the transfer rate obtained at the port. For example, the maximum value of the transfer rate of the port 3 of the transfer apparatus 10c is 1 Gbps. Meanwhile, the monitoring unit 31 has acquired the calculation result that the transfer rate of the port 3 of the transfer apparatus 10c is 800 Mbps from the statistical information acquisition unit 41. Therefore, the monitoring unit 31 determines that the use rate of the port 3 of the transfer apparatus 10c is 800 Mbps/1 Gbps×100=80%. The monitoring unit 31 compares the obtained use rate and the control threshold value 53 (refer to FIG. 7) with each other and decides that the load on the port 3 of the transfer apparatus 10c reaches the control threshold value 53. Therefore, the monitoring unit 31 determines to perform control for decreasing the transfer speed of the flow to be transferred through the port 3 of the transfer apparatus 10c.

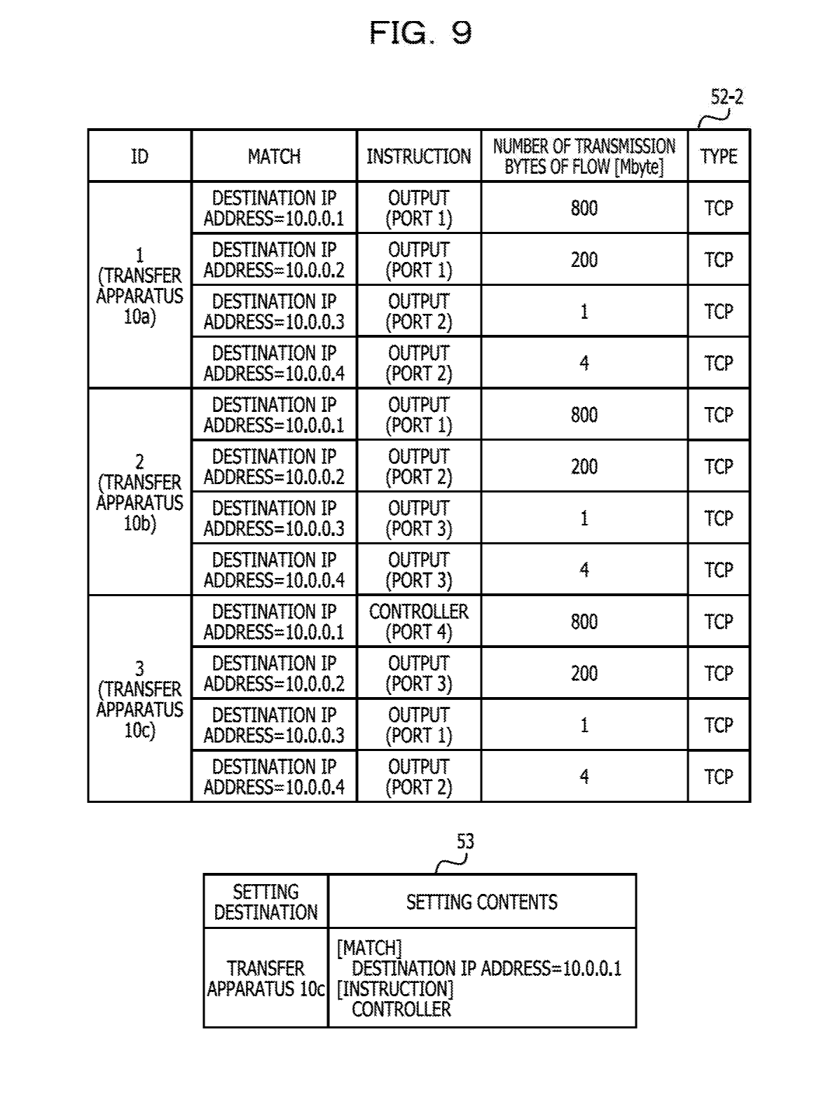

It is assumed that the generation unit 42 generates a control message for changing at least one transfer destination of a flow to be transferred through the port 3 of the transfer apparatus 10c to the control apparatus 20. In the example of FIG. 8, it is assumed that the generation unit 42 generates a process rule for requesting the transfer apparatus 10c to transfer the flow F1 to the control apparatus 20 and updates the flow table 52-1 to a flow table 52-2 (FIG. 9). Furthermore, the generation unit 42 stores information of the flow table 52-1 before the updating as information to be used after an end of the rate control.

FIG. 9 is a view illustrating an example of an updating process for the flow table 52. In the flow table 52-2 depicted in FIG. 9, the Instruction for a flow (flow F1) whose destination IP address=10.0.0.1 in the transfer apparatus 10c is set to CONTROLLER. Here, it is assumed that Instruction=CONTROLLER signifies a transfer process to the control apparatus 20. It is to be noted that, in the example of FIG. 9, processes for flows other than the flow F1 in the transfer apparatus 10c are same as the processes of the flow table 52-1 (FIG. 7).

The generation unit 42 generates a control message for notifying the transfer apparatus 10c of the changed process rule. For example, it is assumed that the generation unit 42 generates a FlowMod message for requesting the transfer apparatus 10c to transfer a flow whose destination IP address=10.0.0.1 to the control apparatus 20. The generation unit 42 transmits the generated FlowMod message to the transfer apparatus 10c through the transmission unit 22.

The generation unit 42 stores contents of the new process rule notified of in order to perform control of the transfer rate and the information of the transfer apparatus 10 of the notification destination as control target information 54 into the storage unit 50. In FIG. 9, an example of the control target information 54 that is generated when the transfer destination of the flow F1 is changed to the control apparatus 20 in the transfer apparatus 10c is indicated.

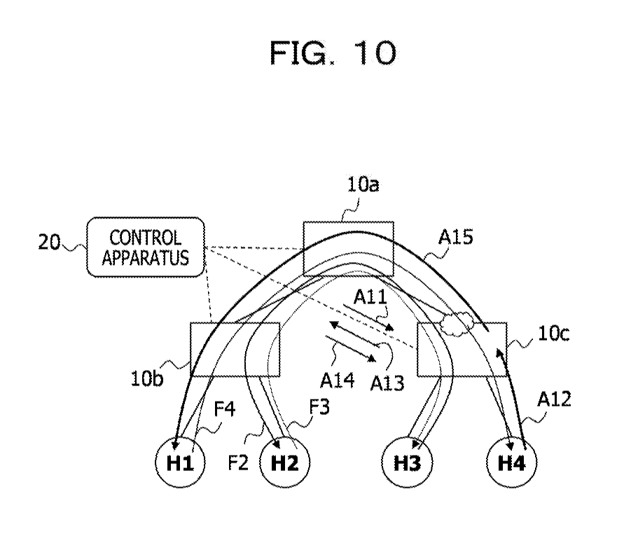

FIG. 10 is a view illustrating an example of a communication method. An arrow mark A11 indicates that the control apparatus 20 transmits a FlowMod message including a process rule to be changed for control of the transfer rate to the transfer apparatus 10c. Consequently, the transfer apparatus 10c changes the process to be applied to the flow F1 to the process rule notified of from the control apparatus 20. At this time, the transfer apparatus 10c updates the stored flow table suitably.

Thereafter, it is assumed that the host H4 transmits a packet destined for the host H1 (arrow mark A12). The transfer apparatus 10c outputs the packet destined for the host H1 from the port 4 to transfer the packet to the control apparatus 20 (arrow mark A13). Here, it is assumed that the transfer apparatus 10c generates a Packet-In message including the packet destined for the host H1 and transmits the generated Packet-In message to the control apparatus 20.

The reception unit 23 of the control apparatus 20 receives the Packet-In message from the transfer apparatus 10c and outputs the received Packet-In message to the statistical information acquisition unit 41. The statistical information acquisition unit 41 stores the Packet-In message into the buffer 56. The buffer 56 stores the Packet-In message inputted to the buffer 56 from the statistical information acquisition unit 41 for a given period of time and then outputs the Packet-In message to the transfer processing unit 43. The transfer processing unit 43 performs a transfer process for the packet included in the Packet-In message. At this time, the transfer processing unit 43 determines the transmission source of the Packet-In message to the transfer destination of the packet in the Packet-In message. Further, the transfer processing unit 43 requests the transmission source of the Packet-In message to transfer the transferred packet toward the destination of the packet. At this time, the transfer processing unit 43 may notify the transfer destination of the packet of the output port for the packet of the transfer target to request the transfer destination to perform a transfer process toward the destination. In this case, the transfer processing unit 43 determines the output port at the transfer destination for the packet using the address information and the topology information 55 (FIG. 4) of the packet of the target of the transfer. Since, in the example of FIG. 10, the transmission source of the Packet-In message is the transfer apparatus 10c, the transfer processing unit 43 determines an output port in the transfer apparatus 10c. The destination IP address of the packet in the Packet-In message is 10.0.0.1 (host H1). Therefore, the output port in the transfer apparatus 10c is determined to the port 3.

The transfer processing unit 43 generates, for the transfer apparatus 10c, a control packet that includes the packet in the message inputted from the buffer 56 and the information of the output port in the transfer apparatus 10c for the packet. For example, the transfer processing unit 43 generates a Packet-Out message including the packet destined for the host H1 and the information indicating that the output port for the packet destined for the host H1 is the port 3. The transfer processing unit 43 transmits the generated Packet-Out message to the transfer apparatus 10c through the transmission unit 22 (arrow mark A14).

When the transfer apparatus 10c receives the Packet-Out message, the transfer apparatus 10c outputs the packet included in the Packet-Out message and destined for the host H1 from the port 3 in accordance with the Packet-Out message. Therefore, the packet destined for the host H1 is transferred toward the host H1 (arrow mark A15).

In this manner, if control by the control apparatus 20 is performed, the period of time until a packet of the flow F1 arrives at the destination becomes longer than that when the control is not performed. The increasing amount of the time period until a packet arrives at the destination is the sum of a period of time over which a packet makes a reciprocating movement between the transfer apparatus 10c and the control apparatus 20 and a period of time for which the packet is retained in the control apparatus 20. Therefore, the transfer speed of a packet in the flow F1 is slowed down and the time for an acknowledge response packet arriving to the host H4, which is a transmission source of a packet of the flow F1, from the host H1 increases. Since the host H4 performs transmission of a packet of the flow F1 in response to reception of the acknowledge response packet, the transmission rate of the flow F1 from the host H4 decreases by the delay process performed by the control apparatus 20. Accordingly, the transfer rate of packets at the port 3 of the transfer apparatus 10c decreases.

Also while a delay process for a packet is performed by the control apparatus 20, the statistical information acquisition unit 41 in the control apparatus 20 periodically acquires a communication situation from each transfer apparatus 10 and suitably updates information of the transfer apparatus information 51, the flow table 52 and so forth. Further, the statistical information acquisition unit 41 calculates the transfer rate at each of the ports provided on each transfer apparatus 10 in accordance with the latest information. The monitoring unit 31 regularly performs a comparison process between the calculated transfer rate and the control threshold value 53. If the use rate of the port 3 of the transfer apparatus 10c becomes lower than the control threshold value 53, the monitoring unit 31 determines to end the rate control process.

At the end of the rate control, the generation unit 42 returns the flow table 52 to its state before the rate control is performed using the control target information 54. For example, in the example of the flow table 52-2 (FIG. 9), the generation unit 42 refers to the control target information 54 to recognize that a transfer process for the flow F1 by the transfer apparatus 10c is changed. Further, the generation unit 42 stores, upon updating of the flow table 52, the information of the flow table 52-1 (FIG. 7) before the rate control is started as information to be used after the end of the updating. Therefore, the generation unit 42 updates the flow table 52-2 to the state of the flow table 52-1 using the information stored. According to the flow table 52-1 having been used before the start of the rate control, the transfer apparatus 10c changes the output destination of a packet of the flow F1 to the port 3. Further, the generation unit 42 deletes the information relating to the change of the process rule for the flow F1 from the control target information 54.

The generation unit 42 transmits a control packet for requesting the transfer apparatus 10c to perform the process having been performed before the start of the rate control. At this time, the generation unit 42 may use a FlowMod message as the control packet.

If the control packet is processed in the transfer apparatus 10c, the flow table in the transfer apparatus 10c is updated to the state before the start of the rate control. Accordingly, a packet of the flow F1 is outputted from the port 3 without passing the control apparatus 20, and the transfer of a packet of the flow F1 from the transfer apparatus 10c to the control apparatus 20 ends.

If the state in which the use rate exceeds the control threshold value 53 is cancelled by the rate control in this manner, the generation unit 42 may end the process for delaying transfer of a packet of the flow F1 in the control apparatus 20. Accordingly, if the end of the rate control is determined, the transfer process along the route described hereinabove with reference to FIG. 8 is re-started.

It is to be noted that the generation unit 42 may determine a transfer rule for a flow recorded in the control target information 54 using the topology information 55 in place of storing the information of the flow table 52-1 (FIG. 7) before the start of the rate control. The generation unit 42 applies the new process determined using the topology information 55 such that the transfer process in the network system is returned to the state before the start of the rate control.

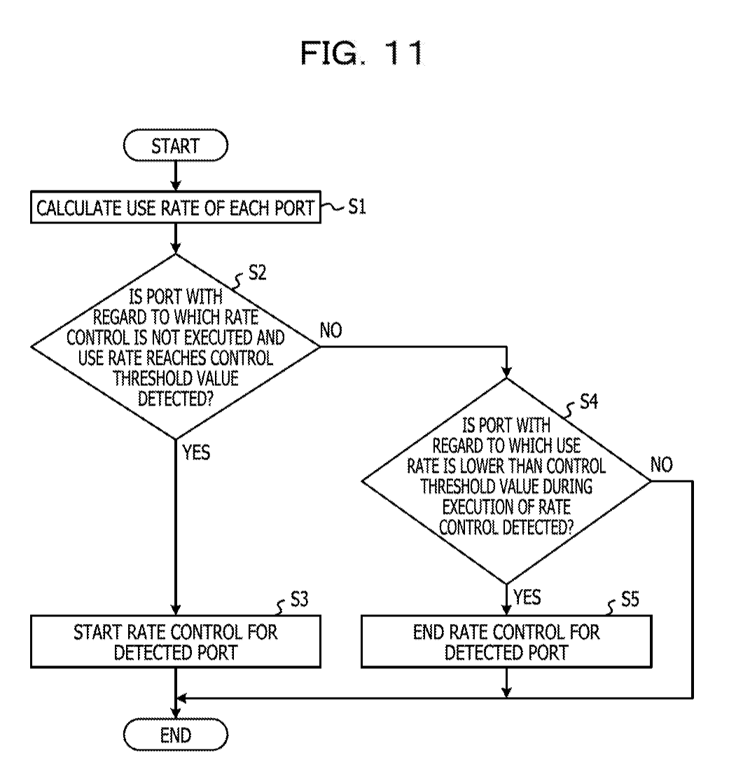

FIG. 11 is a flow chart illustrating a decision process for a start and an end of rate control. The statistical information acquisition unit 41 calculates the use rate of each port using the transfer apparatus information 51 (step S1). The monitoring unit 31 decides whether there is a port that is in a state in which the rate control is not being performed and with regard to which the use rate reaches the control threshold value 53 (step S2). If a port is detected which is in a state in which the rate control is not being performed and with regard to which the use rate reaches the control threshold value 53, the monitoring unit 31 starts rate control for the detected port (Yes at step S2, and step S3).

On the other hand, if a port is not detected which is in a state in which the rate control is not being performed and with regard to which the use rate reaches the control threshold value 53 (No at step S2), the monitoring unit 31 decides whether there is a port for which the rate control is being performed and besides with regard to which the use rate is lower than the control threshold value 53 (step S4). If a port is detected for which the rate control is being performed and besides with regard to which the use rate is lower than the control threshold value 53, the monitoring unit 31 determines to end the rate control for the detected port (Yes at step S4, and step S5). If a port is not detected for which the rate control is being performed and besides with regard to which the use rate is lower than the control threshold value 53, the monitoring unit 31 ends the process (No at step S4).

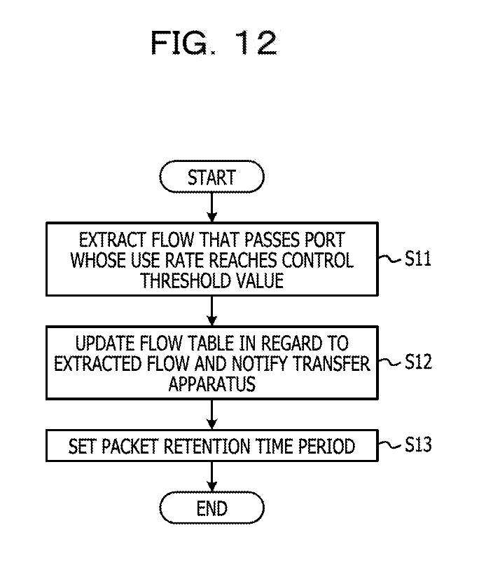

FIG. 12 is a flow chart illustrating an example of a setting process for rate control. It is to be noted that FIG. 12 illustrates an example of process. For example, such a change that the order of steps S12 and S13 is changed may be performed in accordance with actual incorporation. The generation unit 42 extracts a flow that passes a port whose use rate reaches the control threshold value 53 (step S11). The generation unit 42 updates the flow table 52 such that the extracted flow is transferred to the control apparatus 20 and notifies the transfer apparatus 10 of contents after the updating (step S12). It is to be noted that the notification process at step S12 is performed for the transfer apparatus 10 in which the flow table retained as a process rule to be used for process for a packet is changed by the updating of the flow table 52 in the control apparatus 20. Further, the generation unit 42 sets a period of time for which a packet transferred to the control apparatus 20 is to be retained in the buffer 56 (packet retention time period) (step S13).

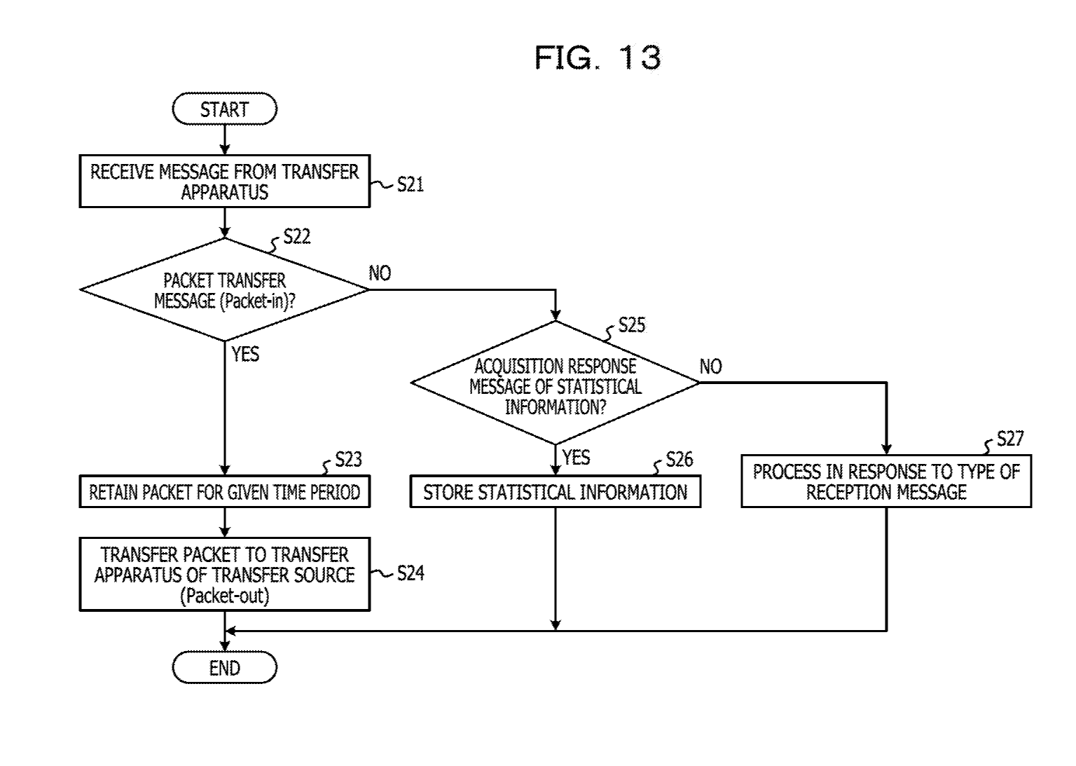

FIG. 13 is a flow chart illustrating an example of details of rate control. The reception unit 23 of the control apparatus 20 receives a message from a transfer apparatus 10 (step S21). The statistical information acquisition unit 41 decides whether the message is a packet transfer message (step S22). Here, the packet transfer message is an arbitrary message used to transfer a packet from the transfer apparatus 10 to the control apparatus 20. For example, as the packet transfer message, a Packet-In message may be used.

If the received message is a packet transfer message, the statistical information acquisition unit 41 stores the packet transfer message into the buffer 56 (Yes at step S22). The buffer 56 retains the packet transfer message over a preliminarily determined given period of time and thereafter outputs the packet transfer message to the transfer processing unit 43 (step S23). The transfer processing unit 43 transfers the packet included in the packet transfer message to the transmission source of the packet transfer message (step S24). At this time, the transfer processing unit 43 transfers also information for requesting the transfer apparatus 10 of the transfer destination to output the packet of the transfer target toward the destination together with the packet of the transfer target. For example, the transfer processing unit 43 may generate a Packet-Out message including the packet of the transfer target and the information of the output port at the transfer destination of the packet. The Packet-Out message generated by the transfer processing unit 43 is transmitted through the transmission unit 22.

On the other hand, if the received message is not a packet transfer message, the statistical information acquisition unit 41 decides whether the received message is an acquisition response message of statistical information (No at step S22, and step S25). If the received message is an acquisition response message of statistical information, the statistical information acquisition unit 41 stores the acquired statistical information into the storage unit 50 (Yes at step S25, and step S26). It is to be noted that the statistical information acquisition unit 41 may suitably update the transfer apparatus information 51 and the flow table 52 using information notified of by the acquisition response message. If the received message is not an acquisition response message of statistical information either, process in accordance with a type of the received massage is performed (No at step S25, and step S27).

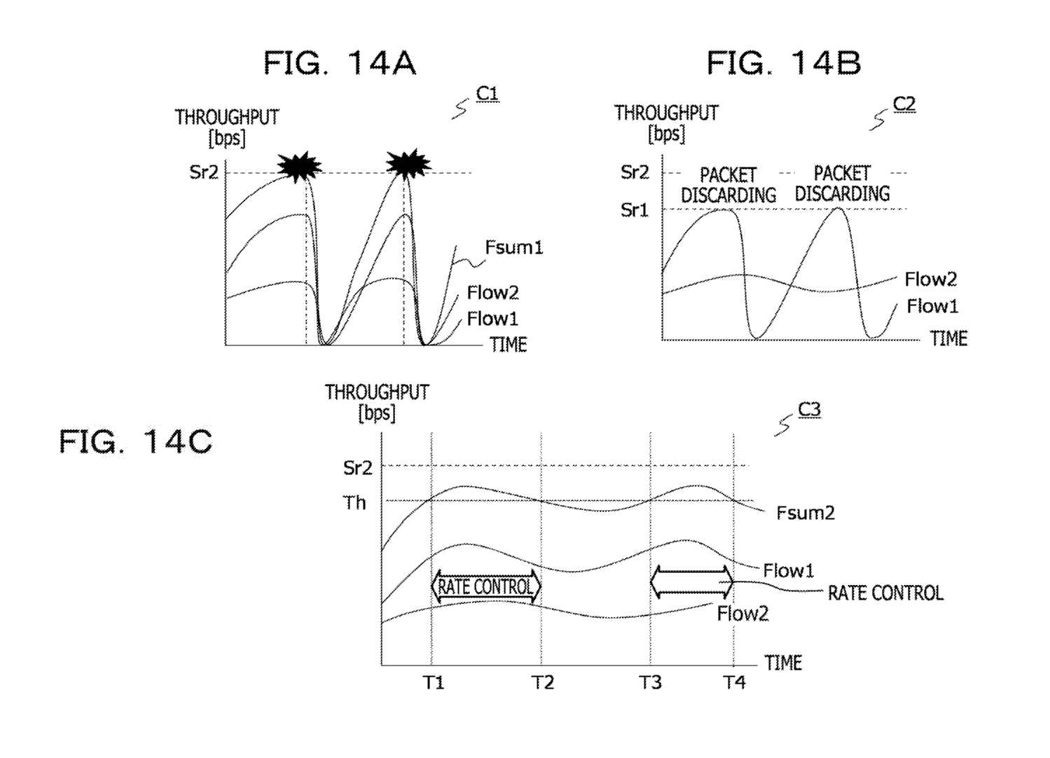

FIGS. 14A, 14B and 14C illustrate examples of a time variation of throughput. FIGS. 14A, 14B and 14C illustrate variation examples of the throughput in both of a system in which the method according to the first embodiment is applied and another system in which the method according to the first embodiment is not applied. A case C1 (FIG. 14A) and a case C2 (FIG. 14B) indicate time variations of the throughput in the system in which the method according to the first embodiment is not applied. The case C2 is ready for a drop process for a packet. A case C3 (FIG. 14C) indicates an example of a time variation of the throughput in the system in which the method according to the first embodiment is applied. Further, in all cases, the maximum value of the throughput at the ports is Sr2.

In the case C1, the throughput at the ports used for transmission and reception of the flows Flow1 and Flow2 increases together with an increase of the transfer rate of each flows. In the case C1, the sum of the throughputs of the flows Flow1 and Flow2 is indicated as Fsum1. If the sum Fsum1 exceeds the upper limit Sr2 of the throughput, a buffer overflow occurs with the switch and a packet is discarded. At this time, packets of both flows are discarded. Accordingly, if the throughput sum Fsum1 exceeds the upper limit Sr2 of the throughput, the throughput decreases suddenly in both flows, and therefore, the throughput decreases with respect to the communicatable data amount, resulting in sudden degradation of the communication efficiency.

In the case C2, for the flow Flow1 from between the flows Flow1 and Flow2, a process for discarding a packet is performed if a given throughput Sr1 is exceeded. Therefore, in the flow Flow1, if the throughput exceeds the throughput Sr1, since a packet is discarded, the throughput decreases suddenly. On the other hand, a drop process is not performed for the flow Flow2. Consequently, in the case C2, it is easier to decrease the variation of the throughput than in the case C1. However, also in the case C2, if the sum of the throughputs in the flows Flow1 and Flow2 exceeds the upper limit Sr2 to the throughput at the ports, since also a packet in the flow Flow2 is discarded, similarly as in the case C1, the throughputs decrease suddenly in all flows, resulting in degradation of the communication efficiency.

In the case C3, the control threshold value 53 at which the control apparatus 20 starts rate control is indicated as Th. Meanwhile, the sum of the throughputs in the flows Flow1 and Flow2 in the case C3 is represented as Fsum2. The monitoring unit 31 in the control apparatus 20 starts rate control when the throughput sum Fsum2 reaches a control threshold value Th at time T1. By the rate control, part of packets are transferred through the control apparatus 20, and further, the control apparatus 20 retains packets over a given period of time. Therefore, the throughput of packets in the flow of the target of the rate control decreases. In the example of the case C3, the flow Flow1 is a target of the rate control. Therefore, if some period of time elapses after the rate control is started at time T1, the throughput begins to decrease. Thereafter, if the throughput sum Fsum2 becomes lower than the control threshold value Th at time T2, the control apparatus 20 ends the rate control. After the rate control ends, the throughput of the flow Flow1 begins to increase again, and at time T3, the throughput sum Fsum2 reaches the control threshold value Th again. Consequently, the control apparatus 20 starts rate control at time T3. If the throughput sum Fsum2 becomes lower than the control threshold value Th at time T4, the rate control is ended.

In this manner, in the case C3, within a period within which the sum value of the throughput exceeds the control threshold value 53, a process for delaying a packet is performed by the control apparatus 20. Since the delay of a packet decreases the throughput moderately, in the case C3 in which the first embodiment is used, such an extreme decrease of the throughput as in the case C1 or the case C2 is not demonstrated. For example, since the control apparatus 20 controls the throughput such that discarding of a packet does not occur, a sudden decrease of the throughput is suppressed. Since a sudden decrease of the throughput is suppressed, the throughput does not become very low with respect to the data amount that may be communicated. Accordingly, in the case C3, the state in which the sum value of the throughputs is comparatively high continues for a longer period of time than that in the case C1 or the case C2. Accordingly, in the system that uses the method according to the first embodiment, decrease of the communication efficiency is suppressed.

It is to be noted that, in the first embodiment, a flow of a target of rate control may be selected by an arbitrary selection method. Accordingly, the generation unit 42 may select, as a target of rate control, an arbitrary number, which is equal to or greater than 1, of arbitrary flows that passes a port whose use rate exceeds a given value.

### Second Embodiment

A second embodiment is directed to a case in which a flow that is a target of a delay process by the control apparatus 20 is limited to a flow in which the ratio of Ack packets is high. Also in the following description, it is assumed that the topology of the network is such as illustrated in FIG. 4. The control apparatus 20 in the second embodiment includes a flow selection unit 32 and an apparatus selection unit 33. The flow selection unit 32 selects a flow of a process target, and the apparatus selection unit 33 determines a transfer apparatus 10 for which a transfer process is to be performed.

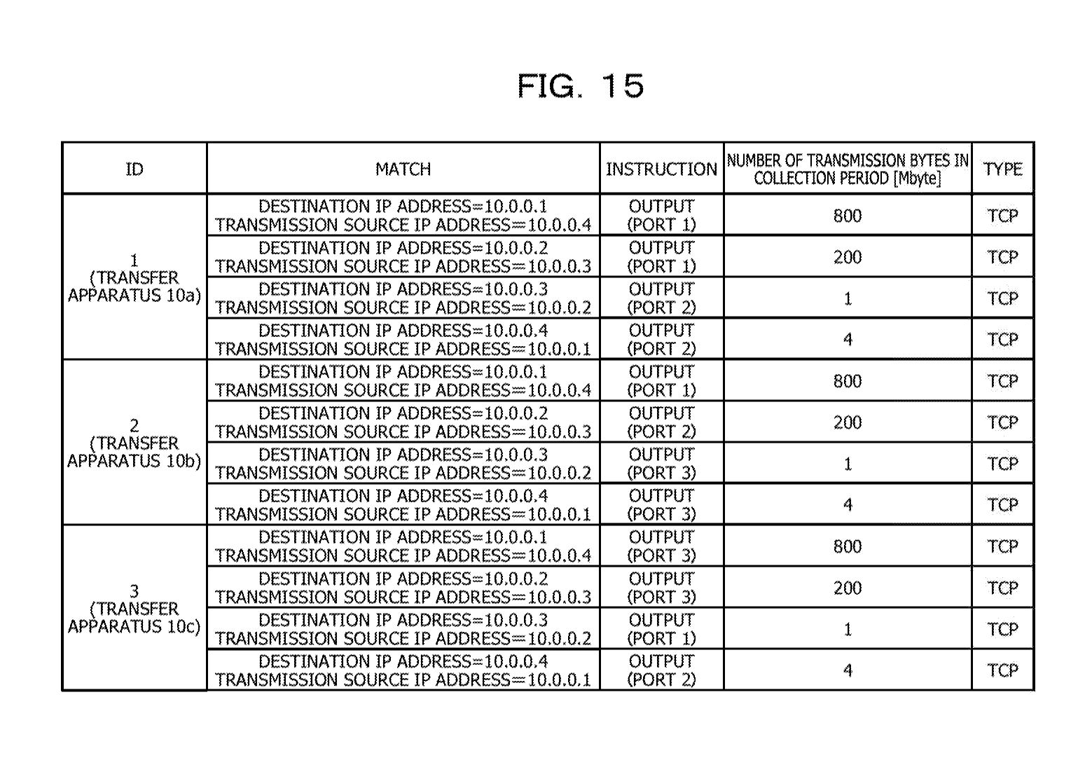

FIG. 15 is a view illustrating an example of a flow table 52 used in the second embodiment. In the second embodiment, a combination of a destination IP address and a transmission source IP address is used as a Match condition. Further, the flow table 52 includes, for each Match condition, an Instruction, the number of transmission bytes in a flow specified by the Match condition, and a protocol type. It is to be noted that the number of transmission bytes and the protocol type are values acquired from the transfer apparatus 10 (10a to 10c) in the system by a process similar to the process in the first embodiment by the statistical information acquisition unit 41.

In the second embodiment, in order to facilitate recognition of the table, a difference obtained by subtracting the number of transmission bytes obtained at the same port upon last collection from the number of transmission bytes obtained from the latest control packet as the number of transmission bytes of a flow is described as the number of transmission bytes in a collection period. For example, the number of transmission bytes in a collection period is a value of the data amount transmitted from a transfer apparatus 10 for every flow within a period after the notification of statistical information in the last cycle until notification of statistical information in the present cycle. Accordingly, in the second embodiment, by using the flow table 52, a combination of a transmission source and a destination, and besides a data amount transmitted and received in the flow may be specified. Therefore, in the second embodiment, by referring to the flow table 52, a flow that is used principally for transmission and reception of data and a flow in which the ratio of Ack packets is high may be specified with regard to a combination of two certain hosts. For example, a flow in which the number of transmission bytes is greater in a collection period in communication between two certain hosts is a flow in which the amount of data in transmission and reception is great. On the other hand, a flow in which the combination of a transmission source and a destination is replaced with a flow in which the amount of transmitted and received data is greater and in which the number of transmission bytes in a collection period is comparatively small is a flow in which the number of transmitted and received Ack packets is greater.

For example, the entry of the first stage from among flows transmitted and received by the transfer apparatus 10a indicates a flow whose destination IP address=10.0.0.1 and transmission source IP address=10.0.0.4, and the number of transmission bytes in a collection period is 800 Mbytes. Accordingly, it is considered that the flow of this entry is used for transmission and reception of data. On the other hand, the entry of the fourth stage from among flows transmitted and received by the transfer apparatus 10a indicates the destination IP address=10.0.0.4 and the transmission source IP address=10.0.0.1, and the number of transmission bytes in a collection period is 4 Mbytes. Accordingly, it may be decided that a flow of the entry of the fourth stage associated with the transfer apparatus 10a is used for transmission and reception of Ack packets of data transmitted and received in the flow of the entry of the first stage associated with the transfer apparatus 10a. Also with regard to any other entry, which number of data packets and Ack packets is greater may be decided similarly. It is to be noted that FIG. 15 illustrates an example, and the numerical values such as the number of transmission bytes in a flow may be changed arbitrarily in accordance with actual incorporation.

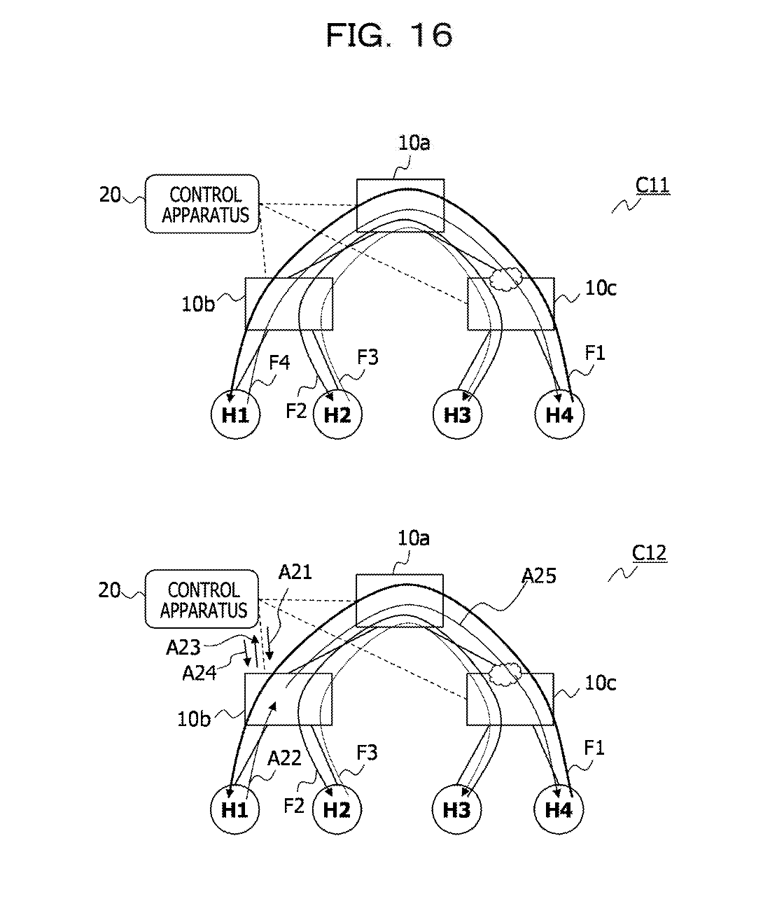

A case C11 of FIG. 16 indicates a transfer route of each flow in a state in which the flow table 52 in FIG. 15 is obtained. In the following, an example of process performed when the use rate of the port 3 of the transfer apparatus 10c reaches the control threshold value 53 is described.

First, the monitoring unit 31 notifies the flow selection unit 32 and the generation unit 42 that the use rate of a port reaches the control threshold value 53. The processes for calculation and so forth of a use rate of a port are similar to the processes in the first embodiment.

The flow selection unit 32 selects a candidate for a flow whose transfer rate is to be decreased by flow control. At this time, the flow selection unit 32 refers to the flow table 52 (FIG. 15) to search for a flow for which the output of a port whose use rate reaches the control threshold value 53 is set as an Instruction. In the example of FIG. 15, the first and second entries in the field of the transfer apparatus 10c are extracted as candidates for a flow whose transfer rate is to be decreased. The flow selection unit 32 calculates the transfer rate for each of the candidates for a flow whose transfer rate is to be decreased using the transmission byte amount and the collection period and selects that one of the flows in which the transfer rate is higher as the flow whose transfer rate is to be decreased. In the example of FIG. 15, the flow whose transmission IP address=10.0.0.1 and transmission source IP address=10.0.0.4 (F1 in FIG. 16) is selected as a flow whose transfer rate is to be decreased.

The flow selection unit 32 selects a flow whose transfer route is to be changed in order to decrease the transfer rate of the selected flow F1. The flow F1 selected as a flow whose transfer rate is to be decreased is a communication flow by the TCP. Therefore, whichever one of a data packet and an Ack packet is delayed, the transfer rate of data packets may be decreased. Ack packets are smaller in amount of data than data packets, and besides, where a Delay Ack packet is applied, the number of Ack packets is smaller than the number of data packets. Therefore, the flow selection unit 32 determines a flow in which Ack packets of data packets are transmitted and received in the selected flow F1 as a flow whose transfer route is to be changed. The flow selection unit 32 decides that the flow whose transmission IP address=10.0.0.4 and transmission source IP address=10.0.0.1 (F4 in FIG. 16) includes Ack packets of data packets transmitted in the flow F1 and determines the flow as a flow whose transfer route is to be changed. In the following description, a flow whose transfer route is to be changed is sometimes referred to as “flow that becomes a control target.” The flow selection unit 32 notifies the apparatus selection unit 33 of the flow whose transfer route is to be changed.

The apparatus selection unit 33 determines a transfer apparatus 10 whose transfer route is to be changed. First, the apparatus selection unit 33 refers to the flow table 52 using a Match condition of the flow F4 notified of from the flow selection unit 32 as a key to specify a transfer route of the flow F4. In the example of FIGS. 15 and 16, the transfer route of the flow F4 is the host H1, the transfer apparatus 10b (outputted from the port 3), the transfer apparatus 10a (outputted from the port 2), the transfer apparatus 10c (outputted from the port 2), and the host H4. Therefore, the apparatus selection unit 33 determines that the transfer apparatus 10b nearest to the transmission source in the transfer route is to transfer a packet of the flow F4 to the control apparatus 20. The apparatus selection unit 33 notifies the generation unit 42 of the result of the selection and the flow of the control target.

In the following, an example of rate control is described with reference to a case C12. The generation unit 42 generates a FlowMod message in order to cause the transfer apparatus 10b to transfer a packet of the flow F4 to the control apparatus 20 in accordance with a notification from the apparatus selection unit 33. In the FlowMod message, it is described that a flow whose destination IP address=10.0.0.4 (host H4) and transmission source IP address=10.0.0.1 (host H1) is to be transferred to the control apparatus 20. The generation unit 42 transmits the generated FlowMod message to the transfer apparatus 10b through the transmission unit 22 (arrow mark A21). Further, the generation unit 42 updates also the flow table 52 and the control target information 54 in accordance with the notification to the transfer apparatus 10b.

On the other hand, the transfer apparatus 10b that receives the FlowMod message from the control apparatus 20 changes the process to be applied to the flow F4 to the process for the process rule in the FlowMod message notified of from the control apparatus 20.

It is assumed that, after the flow table is updated in the transfer apparatus 10b, the host H1 transmits a packet destined for the host H4 (arrow mark A22). When the transfer apparatus 10b receives the packet destined for the host H4 from the host H1, the transfer apparatus 10b transfers a received packet to the control apparatus 20 in accordance with the flow table after updated (arrow mark A23). At this time, the transfer apparatus 10b generates a Packet-In message including the packet destined for the host H4 and transmits the generated Packet-In message to the control apparatus 20. The process performed in the control apparatus 20 is similar to the process described hereinabove with reference to the arrow marks A13 and A14 in FIG. 10. For example, after the control apparatus 20 retains the packet transferred by the Packet-In message for a given period of time and then outputs a Packet-Out message including the packet to the transfer apparatus 10b (arrow mark A24). It is to be noted that the Packet-Out message includes information of an output port at the transfer apparatus 10b of the packet included in the Packet-Out message.

When the transfer apparatus 10b receives the Packet-Out message, the transfer apparatus 10b outputs the packet included in the Packet-Out message and destined for the host H4 in accordance with the Packet-Out message. Therefore, the packet destined for the host H4 is transferred toward the host H4 (arrow mark A25).

Since control by the control apparatus 20 is performed in this manner, the period of time until the packet of the flow F4 reaches the host H4 is longer than that where control by the control apparatus 20 is not performed. Since the flow F4 includes an Ack packet of a data packet transmitted in the flow F1, also the transfer rate of packets in the flow F1 is decreased by the control for the flow F4. Accordingly, the transfer rate of packets at the port 3 of the transfer apparatus 10c decreases.

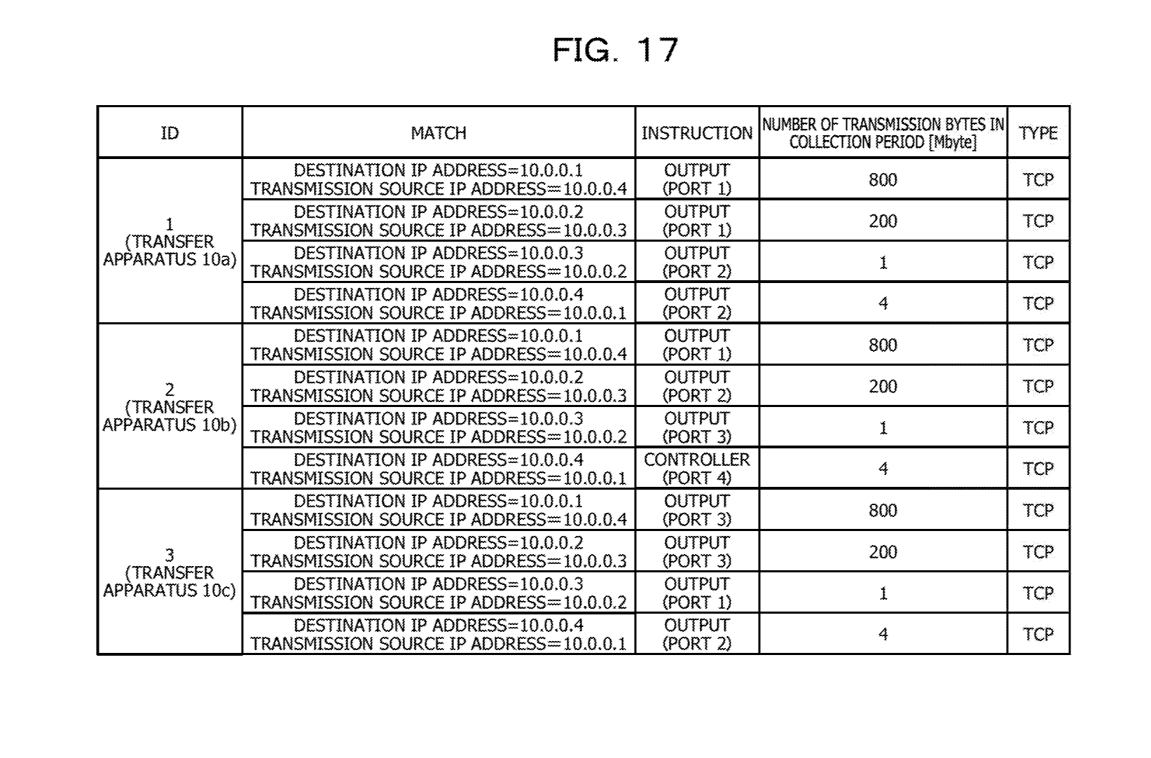

FIG. 17 is a view illustrating an example of updating of the flow table 52. FIG. 17 depicts an example of the flow table 52 obtained by the updating process performed by the generation unit 42 in parallel with the process for the arrow mark A21 in FIG. 16. In the process for the arrow mark A21 in FIG. 16, since the transfer apparatus 10b transfers the flow F4 whose destination IP address=10.0.0.4 and transmission source IP address=10.0.0.1 to the control apparatus 20, the flow table 52 is updated from that illustrated in FIG. 15 to that illustrated in FIG. 17.

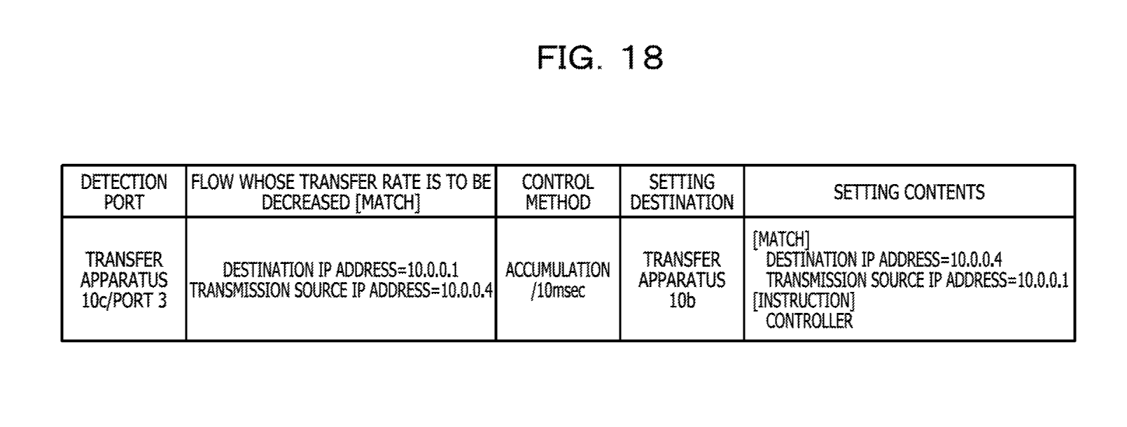

FIG. 18 is a view illustrating an example of the control target information 54. FIG. 18 indicates the example of the control target information 54 updated upon the process for the arrow mark A21 in FIG. 16. In the second embodiment, a transfer apparatus 10 in which the use rate exceeds the control threshold value 53 and a transfer apparatus 10 in which setting for rate control is to be performed may be same as or different from each other. In the example of FIG. 18, the transfer apparatus 10 (setting destination) for which setting for rate control is to be performed, and besides a combination (detection port) of the transfer apparatus 10 and the port with regard to which it is detected that the load is high are recorded in the control target information 54. In the second embodiment, further, since a flow whose transfer rate is to be decreased and a flow that is made a control target may be different from each other, the control target information 54 in FIG. 18 includes information of the flow whose transfer rate is to be decreased and information of the flow that is made a control target. It is to be noted that the information of the flow to be made a control target is recorded as setting contents together with the process rule.

It is to be noted that FIG. 18 illustrates an example of the control target information 54, and the information factors in the control target information 54 may be changed in accordance with actual incorporation. For example, although to store a packet to be made a control target in the control apparatus 20 and a period of time for the storage process are recorded as the control method in the control target information 54, the control target information 54 may not include information of the control method.

Where the control target information 54 illustrated in FIG. 18 is retained, the monitoring unit 31 periodically monitors the use rate of the port 3 of the transfer apparatus 10c. If the monitoring unit 31 decides that the use rate of the port 3 of the transfer apparatus 10c is lower than the control threshold value 53, the monitoring unit 31 determines to end the rate control process. A process upon the end of the rate control process is similar to the process in the first embodiment.

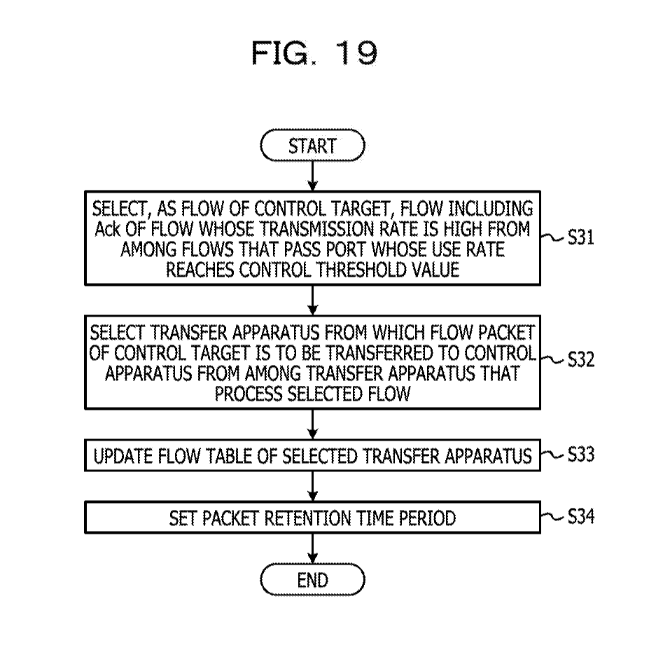

FIG. 19 is a flow chart illustrating an example of a setting process in the second embodiment. The flow selection unit 32 selects a flow that includes an Ack packet in a flow in which the transmission rate is high from among flows that pass those ports whose use rate reaches the control threshold value 53 as a flow of a control target (step S31). The apparatus selection unit 33 selects, from among the transfer apparatus 10 that process the selected flow, a transfer apparatus 10 from which a packet of the flow of the control target is to be transferred to the control apparatus 20 (step S32). The generation unit 42 transmits a FlowMod message to update the flow table of the selected transfer apparatus 10 (step S33). Further, the generation unit 42 sets a period of time (packet retention time period) for retaining the packet transferred to the control apparatus 20 in the buffer 56 (step S34).

If the second embodiment is used, similar advantageous effects to those achieved by the first embodiment may be achieved. Besides, since the control apparatus 20 does not retain a data packet, the process load on the control apparatus 20 is liable to be reduced in comparison with the process load in the first embodiment.

### Third Embodiment

A third embodiment is directed to an example of a process when a flow of a control target is determined taking the traffic in the opposite direction into consideration. Also in the third embodiment, the control apparatus 20 includes a flow selection unit 32 and an apparatus selection unit 33.

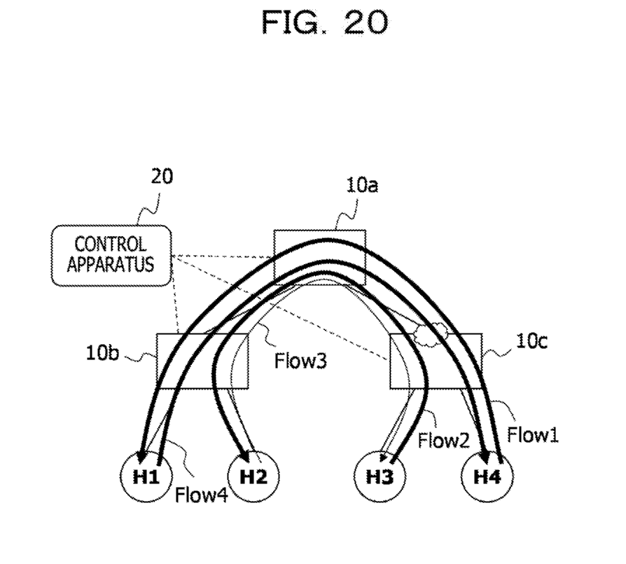

FIG. 20 is a view illustrating an example of a communication process performed in the third embodiment. In FIG. 20, it is to be noted that the thickness of an arrow mark of each flow increases in proportion to the transfer rate of the flow. For example, a flow Flow1 is a flow of a packet directed from the host H4 toward the host H1, and the transmission rate is 400 Mbps. A flow Flow2 is a flow of a packet transmitted from the host H3 to the host H2 and the transmission rate is 400 Mbps. A flow Flow4 is a flow of a packet transmitted from the host H1 to the host H4 and is a flow in the opposite direction to that of the flow Flow1. Also the transmission rate of the flow Flow4 is 400 Mbps. A flow Flow3 is a flow of a packet transmitted from the host H2 to the host H3 and is a flow in the opposite direction to that of the flow Flow2. The transmission rate of the flow Flow3 is 2 Mbps. A case in which such flows as illustrated in FIG. 20 are generated may be a case in which the host H1 and the host H4 perform transmission and reception of much data therebetween and the host H3 transmits data to the host H2. For example, from the host H2 to the host H3, a small amount of data of Ack packets of the TCP or the like is transmitted.

It is assumed that, in this state, the use rate of the port 3 of the transfer apparatus 10c reaches the control threshold value 53. Consequently, the flow selection unit 32 selects flows outputted from the port 3 of the transfer apparatus 10 as candidates for a flow whose transfer rate is to be decreased by flow control. Although, in the example of FIG. 20, the flows Flow1 and Flow2 become candidates, since both of the transmission rates in the flows Flow1 and Flow2 are 400 Mbps, whichever one of the transfer rates of the flows of them is decreased, a similar effect may be expected. Therefore, the flow selection unit 32 compares the transmission rates of flows in the opposite direction for each of the candidates for a flow whose transfer rate is to be decreased. This comparison reveals that, while the transmission rate in the flow Flow4 in the opposite direction to the flow Flow1 is 400 Mbps, the transmission rate in the flow Flow3 in the opposite direction to the flow Flow2 is 2 Mbps. The flow selection unit 32 sets the flow Flow2 whose transmission rate is lower in the flow of the opposite direction as the flow whose transfer rate is to be decreased in order to lessen the burden by the retention process by the control apparatus 20. Further, the flow selection unit 32 selects the flow (Flow3) in the opposite direction to that of the flow Flow2 whose transfer rate is to be decreased as a flow of the control target. The flow selection unit 32 notifies the apparatus selection unit 33 that the flow of the control target is the flow Flow3.

The apparatus selection unit 33 determines, from among the transfer apparatus 10 that are processing the flow Flow3, the transfer apparatus 10 that is to transfer a packet in the flow Flow3 to the control apparatus 20. In the example of FIG. 20, it is assumed that the apparatus selection unit 33 selects the transfer apparatus 10b as the transfer apparatus 10 from which a packet of the flow Flow3 is to be transferred to the control apparatus 20. Consequently, the generation unit 42 transmits a FlowMod message destined for the transfer apparatus 10b to the transfer apparatus 10b to change the transfer destination of a packet in the flow Flow3 in the transfer apparatus 10b to the control apparatus 20. Thereafter, the generation unit 42 updates the flow table 52 in order to establish matching between the information regarding the transfer apparatus 10b in the flow table 52 and the flow in the transfer apparatus 10b.

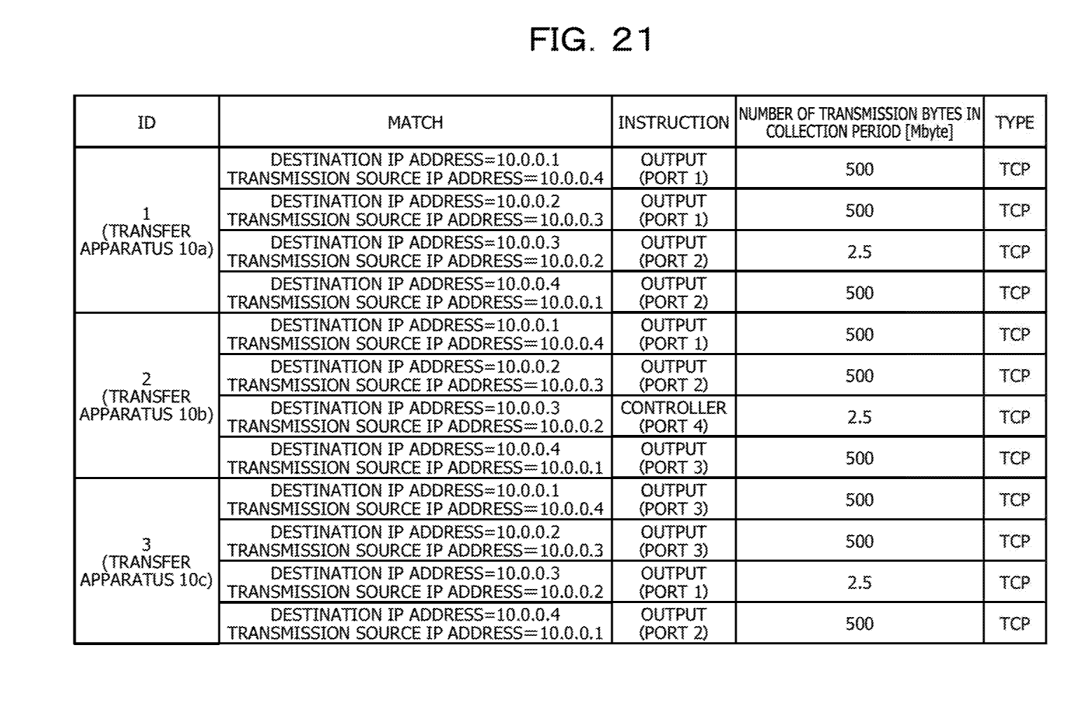

FIG. 21 illustrates an example of the flow table 52 obtained by process by the generation unit 42. In the example of FIG. 21, of the entries of each transfer apparatus 10, the first entry indicates information of the flow Flow1; the second entry indicates information of the flow Flow2; the third entry indicates information of the flow Flow3; and the fourth entry indicates information of the flow Flow4. Where a transmission rate of 400 Mbps is obtained, if the collection period of control information is 10 seconds, the amount of packets transmitted by the flow within one collection period is 500 Mbytes (500 Mbytes×8÷10=400 Mbps). Therefore, in all of the flows Flow1, Flow3, and Flow4, the number of transmission bytes in a period in which control information is acquired is 500 Mbytes. On the other hand, the transmission rate in the flow Flow3 is 2 Mbps. Therefore, the amount of packets transmitted in the flow within one period is 2.5 Mbytes (2.5 Mbytes×8÷10=2 Mbps).

In the flow table 52 illustrated in FIG. 21, the process for a packet in the flow Flow3 by the transfer apparatus 10b is set to transfer to the control apparatus 20. It is to be noted that Instruction=CONTROLLER signifies to transfer a packet satisfying a Match condition to the control apparatus 20.

The processes performed in the transfer apparatus 10b after updating of the flow table are similar to the processes described hereinabove in connection with the second embodiment.

As described in the description of the third embodiment, when a flow in the opposite direction to a flow for which the rate is to be decreased is transferred to the control apparatus 20, as the transmission rate of the flow to be transferred to the control apparatus 20 decreases, the process load to the control apparatus 20 becomes more liable to decrease. Therefore, in the third embodiment, the load upon the control apparatus 20 may be suppressed by the flow selection unit 32 selecting a flow whose rate is to be decreased using the transfer rate of the flow that actually becomes a control target.

### Fourth Embodiment

A fourth embodiment is directed to an example in which the process load upon a plurality of ports is decreased by delaying flows that pass a number of switches as many as possible.

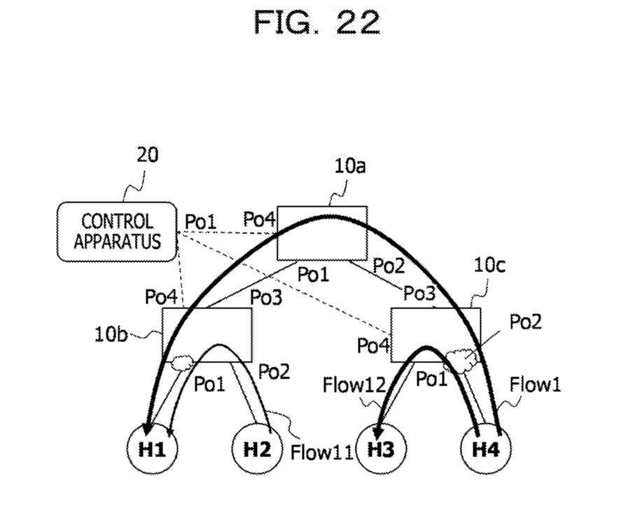

FIG. 22 is a view illustrating an example of a communication process performed in the fourth embodiment. In FIG. 22, a port number is indicated following a character string of alphabetical letters Po. It is to be noted that a coupling scheme between the respective transfer apparatus 10 and between the control apparatus 20 and the transfer apparatus 10 is such as illustrated in FIG. 4.

A flow Flow1 is a flow of a packet that is directed in a direction toward the host H1 from the host H4 and has a transmission rate of 400 Mbps. A flow Flow11 is a flow of a packet transmitted from the host H2 to the host H1 and has a transmission rate of 160 Mbps. A flow Flow12 is a flow of a packet transmitted from the host H4 to the host H3 and has a transmission rate of 400 Mbps.

In all of the flows Flow1, Flow11, and Flow12, communication is performed using the TCP protocol. Accordingly, although communication also by a flow in the opposite direction is performed for each of the flows Flow1, Flow11, and Flow12, in FIG. 22, the flows in the opposite direction are omitted to facilitate recognition of the illustration.

Where such communication is performed, the load upon a port at which a plurality of flows are processed is likely to become high. For example, since the flows Flow1 and Flow12 pass the port (Po2) of the transfer apparatus 10c, the transfer rate is 400 Mbps+400 Mbps=800 Mbps. On the other hand, since the port 1 (Po1) of the transfer apparatus 10b is passed by the flows Flow1 and Flow11, the transfer rate is 400 Mbps+160 Mbps=560 Mbps.

The monitoring unit 31 decides whether rate control is to be performed using a ratio (use rate) by which a transfer rate at each port occupies in an upper limit value to the transfer rate obtained at the port and the control threshold value 53. In the example of FIG. 22, it is assumed that it is decided that the use rate reaches the control threshold value 53 at the port 2 of the transfer apparatus 10c. Further, it is assumed that the monitoring unit 31 decides, as regards the port 1 of the transfer apparatus 10b, that the use rate does not reach the control threshold value 53 although a load of a medium degree is applied to the port 1.

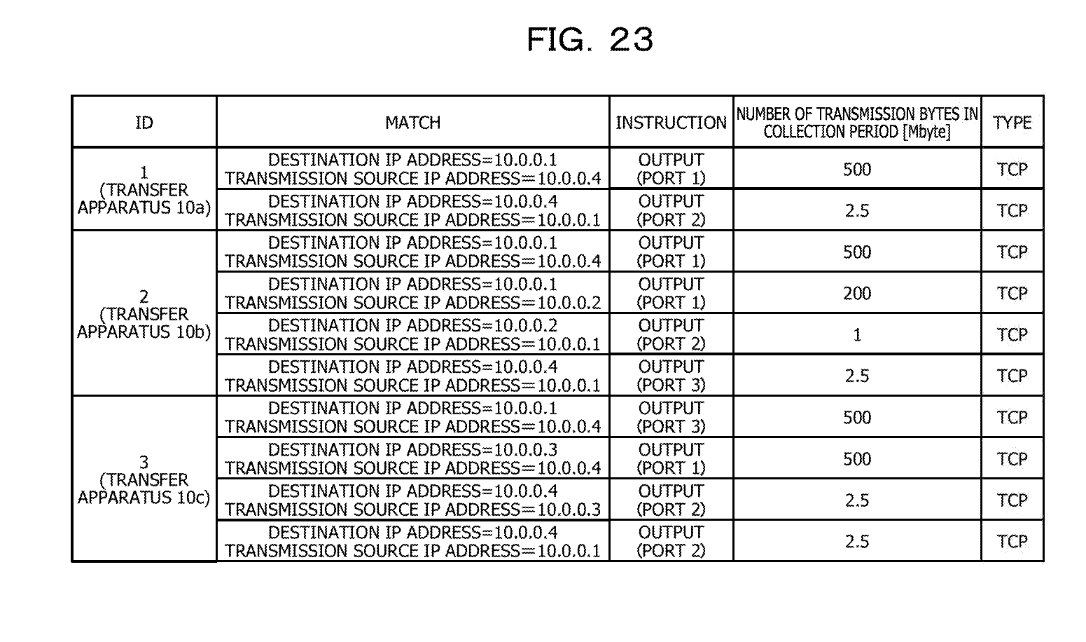

FIG. 23 is a view illustrating an example of the flow table 52 when the communication illustrated in FIG. 22 is being performed. In FIG. 23, of entries regarding the transfer apparatus 10a, the first entry indicates information of the flow Flow1 and the second entry indicates information of a flow in the opposite direction to that of the flow Flow1. Of the entries regarding the transfer apparatus 10b, the first entry indicates information of the flow Flow1; the second entry indicates information of the flow Flow11; the third entry indicates information of the flow in the opposite direction to that of the flow Flow11; and the fourth entry indicates information of the flow in the opposite direction to that of the flow Flow1. Of the entries regarding the transfer apparatus 10c, the first entry indicates information of the flow Flow1; the second entry indicates information of the flow Flow12; the third entry indicates information of the flow in the opposite direction to the flow Flow12; and the fourth entry indicates information of the flow in the opposite direction to that of the flow Flow1.

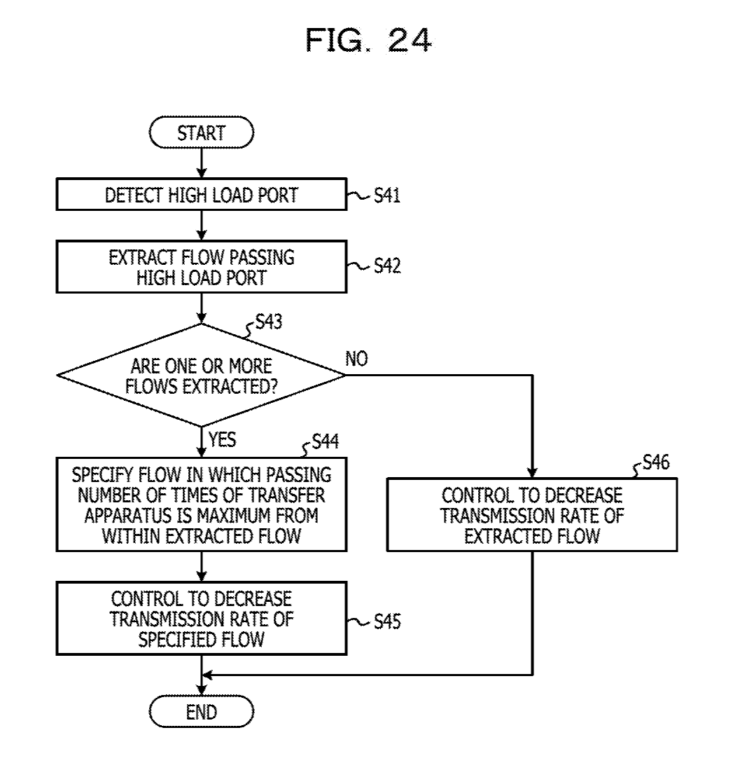

FIG. 24 is a flow chart illustrating an example of process performed in the fourth embodiment. In the following, an example of a rate control when the communication processes illustrated in FIGS. 22 and 23 are being performed is described with reference to FIG. 24.

The monitoring unit 31 detects a port to which a high load is applied (step S41). For example, it is assumed that, since the use rate at the port 2 of the transfer apparatus 10c exceeds the control threshold value 53, the port 2 of the transfer apparatus 10c is detected as a port to which a high load is applied as described hereinabove with reference to FIG. 22. Thus, the flow selection unit 32 extracts a flow passing the high load port by referring to the flow table 52 (FIG. 23) (step S42). In the example of FIG. 23, as a flow outputted from the port 2 of the transfer apparatus 10c, a flow in the opposite direction to the flow Flow12 and a flow in the opposite direction to the flow Flow1 are specified. Further, since it is considered that also a flow in the opposite direction to the flow outputted from the port 2 of the transfer apparatus 10c passes the port 2 of the transfer apparatus 10c, the flow selection unit 32 decides that also the flows Flow1 and Flow12 pass the port 2 of the transfer apparatus 10c. For example, the flow selection unit 32 extracts four flows including the flows Flow1 and Flow12, flow in the opposite direction to the flow Flow1, and a flow in the opposite direction to the flow Flow12.

Then, the flow selection unit 32 decides whether the number of extracted flows is equal to or greater than one (step S43). If the number of extracted flows is one, control for decreasing the transmission rate of the extracted flow is performed (No at step S43, and step S46). It is to be noted that, also when only one flow and a flow in the opposite direction to the one flow are detected, the process at step S46 may be performed.

If a plural number of flows are extracted at step S43, the flow selection unit 32 specifies that one of the extracted flows which indicates a maximum number of transfer apparatus 10 through which the flow passes (Yes at step S43, and step S44). Here, by decreasing the transfer rate in the flow that passes a great number of transfer apparatus 10, there is the possibility that the load to a plurality of ports may be decreased at a time. Therefore, the flow selection unit 32 determines that one of the flows which passes the greatest number of transfer apparatus 10 as a target for which the transmission rate is to be decreased.

The number of transfer apparatus 10 to be passed may be determined using a Match condition of the flow table 52 as a key. For example, since the flow Flow1 is a flow for a packet to be transmitted from the host H4 (10.0.0.4) to the host H1 (10.0.0.1) and passes the transfer apparatus 10a to 10c, the passed number of transfer apparatus 10 is three. Since a flow in the opposite direction to the flow Flow1 is transmitted from the host H1 to the host H4 and passes the transfer apparatus 10a to 10c, the passed number of transfer apparatus 10 is three. Since the flow Flow12 is a flow for a packet transmitted from the host H4 to the host H3 (10.0.0.3) and passes only the transfer apparatus 10c, the passed number of transfer apparatus 10 is one. Since a flow in the opposite direction to the flow Flow12 is a flow of a packet transmitted from the host H3 to the host H4 and passes only the transfer apparatus 10c, the passed number of transfer apparatus 10 is one. Therefore, the flow selection unit 32 decides that the passed number of the transfer apparatus 10 is greatest in the flow (Flow1) of a packet transmitted from the host H4 to the host H1 and the flow in the opposite direction to the flow Flow1.

The flow selection unit 32 determines to decrease the transmission rate of the flow Flow1 because the transfer amount of data in the flow Flow1 is greater than the transfer amount of data in the flow in the opposite direction to the flow Flow1. Further, in order to decrease the burden in retention of packets in the control apparatus 20, the flow selection unit 32 determines the flow to be made a control target upon decrease of the transmission rate of the flow as the flow in the opposite direction to the flow Flow1. The flow selection unit 32 notifies the apparatus selection unit 33 of the flow that is made a control target (flow in the opposite direction to the flow Flow1). Thereafter, control for decreasing the transmission rate of the flow Flow1 by changing the transfer route of the flow in the opposite direction to the flow Flow1 is performed by the apparatus selection unit 33 or the generation unit 42 (step S45).

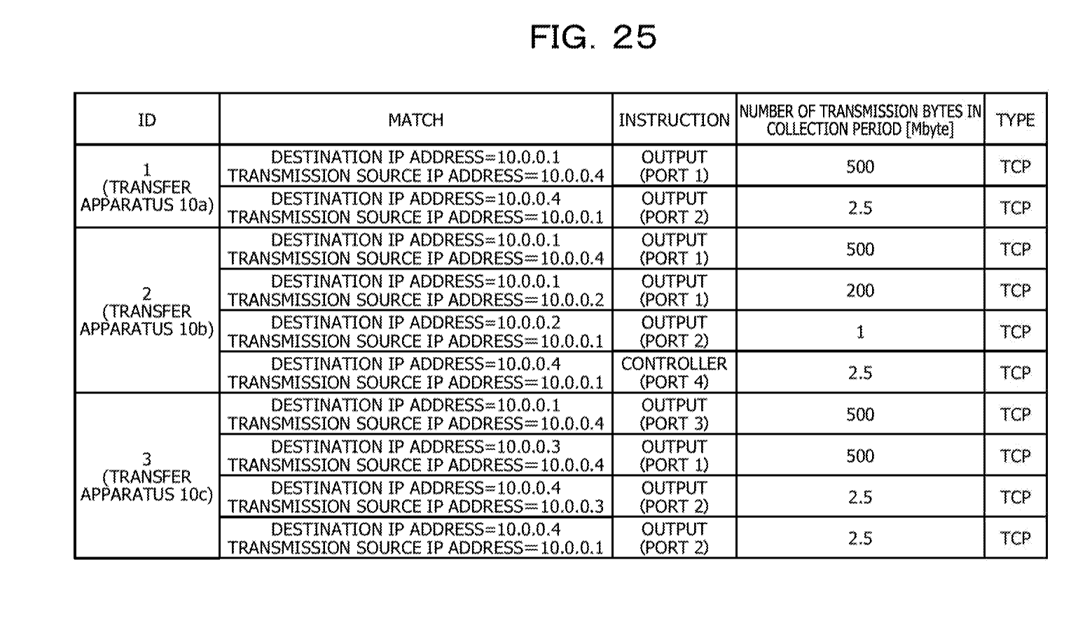

FIG. 25 is a view illustrating an example of updating of a flow table. At step S45 in FIG. 24, the apparatus selection unit 33 is notified that the flow in the opposite direction to the flow Flow1 is a flow of a control target. The apparatus selection unit 33 selects, from among the transfer apparatus 10 that are passed by a flow in the opposite direction to the flow Flow1, the transfer apparatus 10b as an apparatus whose transfer route is to be changed. Consequently, the flow table 52 is updated as illustrated in FIG. 25 from the state of FIG. 23. Later processes are similar to the processes described hereinabove with reference to the second embodiment.

Referring back to FIG. 22, if the transmission rate of the flow Flow1 is decreased, both of the use rate of the port 2 of the transfer apparatus 10c and the use rate of the port 1 of the transfer apparatus 10b may be decreased at a time. In this manner, in the fourth embodiment, by determining a flow whose passed number of transfer apparatus 10 is great preferentially as a target of rate control, the load applied to a plurality of ports may be adjusted efficiently.

### Fifth Embodiment

A fifth embodiment is directed to an example in which a transfer apparatus 10 having the comparatively small number of processes of control messages performs a process for rate control with the load of a control message taken into consideration.

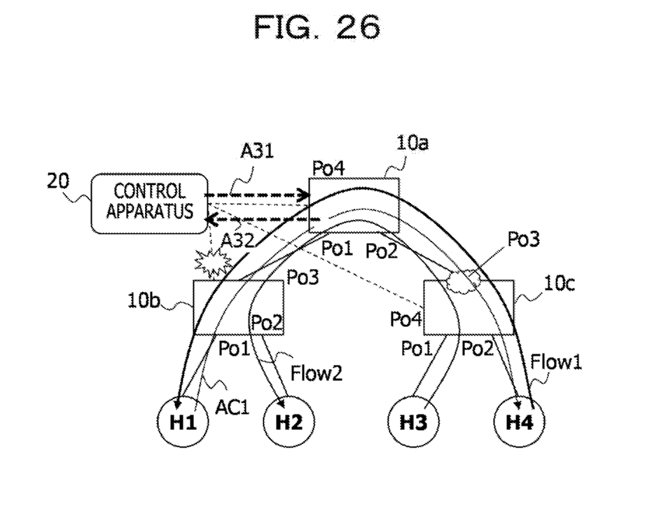

FIG. 26 is a view illustrating an example of a communication process performed in the fifth embodiment. A flow Flow1 is a flow of a packet to be directed in a direction toward the host H1 from the host H4, and a flow Flow2 is a flow of a packet to be transmitted from the host H3 toward the host H2. Further, a flow AC1 is a flow of a packet to be directed in a direction toward the host H4 from the host H1. It is assumed that, when communication illustrated in FIG. 26 is being performed, the control apparatus 20 acquires statistical information from each transfer apparatus 10.

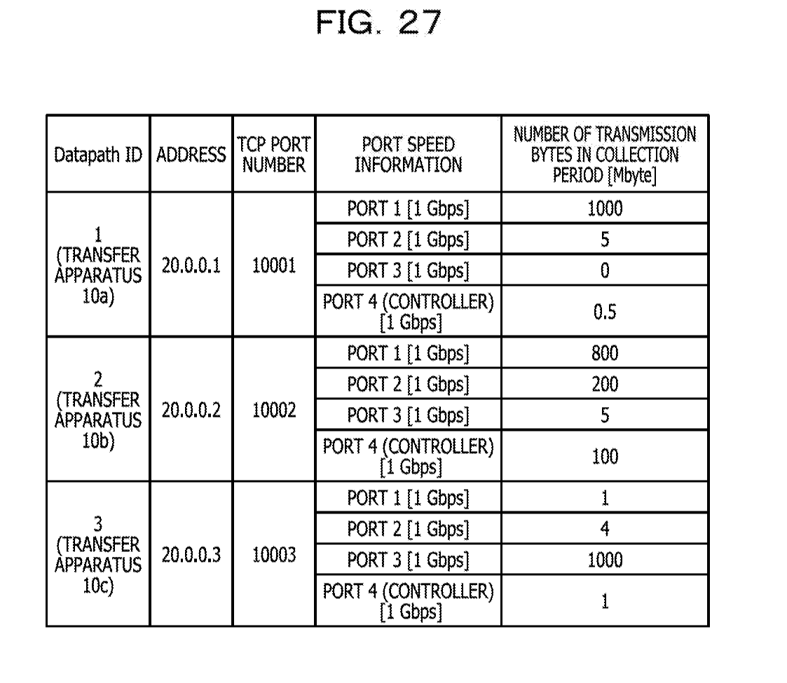

FIG. 27 is a view illustrating an example of transfer apparatus information 51 updated using statistical information obtained when the communication illustrated in FIG. 26 is performed. It is to be noted that, in the example of FIG. 27, the number of transmission bytes is the number of transmission bytes in a collection period. Further, the transfer apparatus information 51 includes a data path ID, an address, a TCP port number, and port speed information.

It is assumed that, when the transfer apparatus information 51 illustrated in FIG. 27 is obtained, the use rate at the port 3 of the transfer apparatus 10c exceeds the control threshold value 53. Consequently, a flow of a control target is determined by a process similar to the process in any of the first to fourth embodiments.

If the apparatus selection unit 33 is notified of a flow of a control target, the apparatus selection unit 33 refers to the transfer apparatus information 51 (FIG. 27) to compare the communication amount between the control apparatus 20 and each of the transfer apparatus 10a to 10c. Since all of the transfer apparatus 10a to 10c are coupled at the port 4 of the transfer apparatus 10 to the control apparatus 20, the apparatus selection unit 33 compares the number of transmission bytes in a collection period at the ports 4 of the transfer apparatus 10. The comparison reveals that the communication amount between the transfer apparatus 10a and the control apparatus 20 is smallest. Therefore, the apparatus selection unit 33 determines the transfer apparatus 10a as an apparatus from which the flow of the control target is to be transferred to the control apparatus 20.

Arrow marks A31 and A32 in FIG. 26 indicate processes to be performed after the determination by the apparatus selection unit 33. The generation unit 42 requests the transfer apparatus 10a in accordance with the determination of the apparatus selection unit 33 to change the transfer destination of a packet of the flow of the control target to the control apparatus 20 (arrow mark A31). The transfer apparatus 10a changes the flow table in response to the request from the control apparatus 20. If the transfer apparatus 10a receives a packet of the flow of the control target after the change of the flow table, the transfer apparatus 10a transfers the received packet to the control apparatus 20 (arrow mark A32). The control apparatus 20 retains the packet of the control target over a given period of time and then outputs the packet to the transfer apparatus 10a together with the information of the output port of the packet. Therefore, the packet is transferred toward the destination in a state in which the packet is delayed by the transfer to the transfer apparatus 10, retention in the control apparatus 20 and so forth.

According to the fifth embodiment, a transfer apparatus 10 whose transfer route is to be changed is determined taking also the situation of a line between the control apparatus 20 and the transfer apparatus 10 into consideration. Therefore, since the transfer apparatus 10 transmits a flow of a control target to the control apparatus 20, the possibility that congestion may occur in the line between the control apparatus 20 and the transfer apparatus 10 decreases.

### Sixth Embodiment

A sixth embodiment is directed to a case in which, in a system that includes a plurality of control apparatus 20, rate control is performed by that one of the control apparatus 20 to which a comparatively low load is applied.

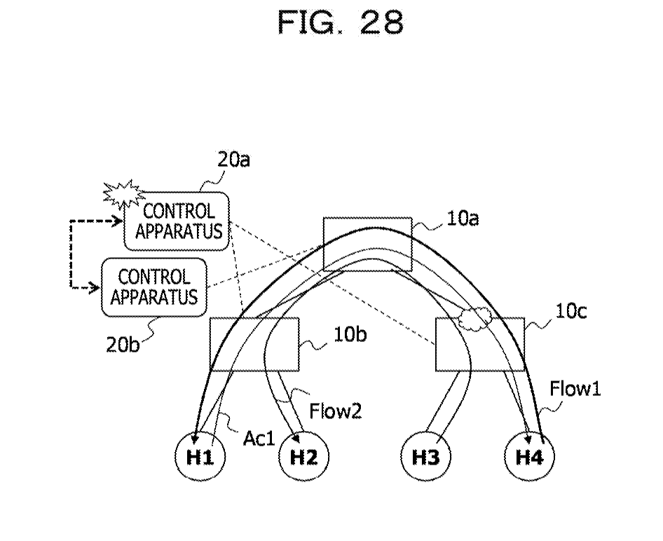

FIG. 28 is a view illustrating an example of a communication process performed in the sixth embodiment. In the sixth embodiment, the system includes two control apparatus 20 including a control apparatus 20a and another control apparatus 20b. It is assumed that the control apparatus 20a is coupled to a transfer apparatus 10b and a transfer apparatus 10c while the control apparatus 20b is coupled to a transfer apparatus 10a. For example, the transfer apparatus 10b and the transfer apparatus 10c are controlled by the control apparatus 20a, and the transfer apparatus 10a is controlled by the control apparatus 20b. Further, the control apparatus 20a and the control apparatus 20b are coupled to each other and share information of the transfer apparatus 10 in the system. The coupling scheme between hosts H1 to H4 and the transfer apparatus 10a to 10c is similar to the coupling scheme in the first to fifth embodiments. For example, the host H1 and the host H2 are coupled to the transfer apparatus 10b, and the host H3 and the host H4 are coupled to the transfer apparatus 10c. Further, the transfer apparatus 10a is coupled to both of the transfer apparatus 10b and the transfer apparatus 10c.

In the system depicted in FIG. 28, it is assumed that communication by a flow (Flow1) of a packet to be directed in a direction toward the host H1 from the host H4 and another flow (Flow2) of a packet transmitted from the host H3 to the host H2 is performed. Further, it is assumed that also communication by a flow (Ac1) of a packet to be directed in a direction toward the host H4 from the host H1 is performed. It is assumed that, when the communication illustrated in FIG. 28 is performed, the control apparatus 20a acquires statistical information from the transfer apparatus 10b and the transfer apparatus 10c. Further, it is assumed that the control apparatus 20b acquires statistical information from the transfer apparatus 10a. The control apparatus 20a notifies the control apparatus 20b of the statistical information acquired by the control apparatus 20 through the coupling to the control apparatus 20b and acquires statistical information acquired by the control apparatus 20b.

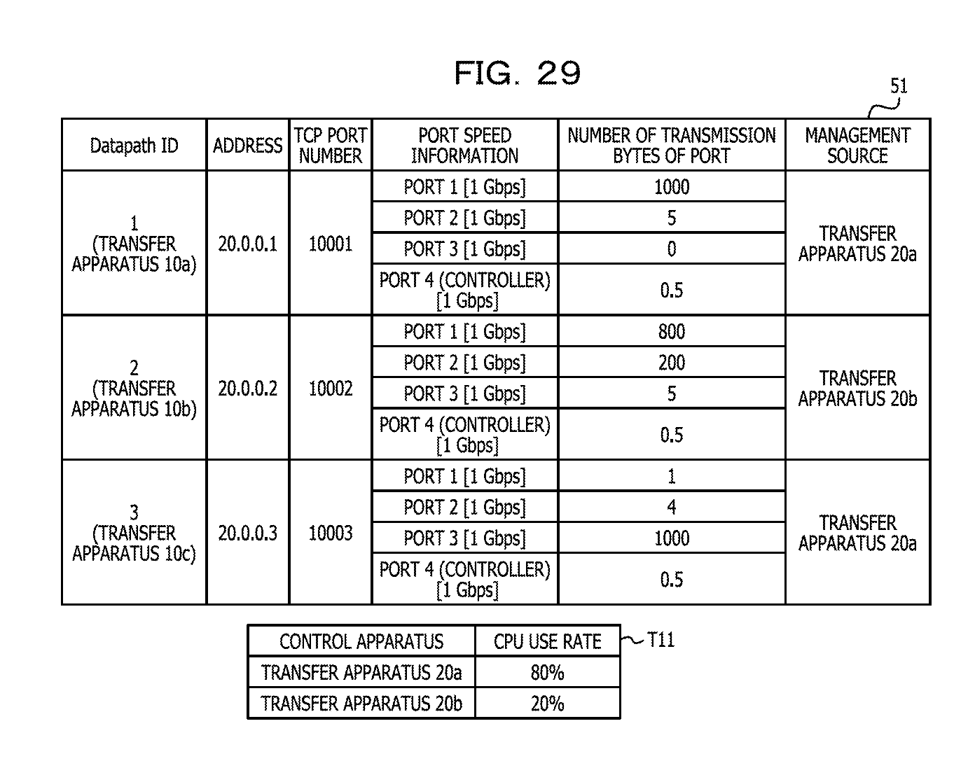

FIG. 29 is a view illustrating an example of information retained by each control apparatus 20. The transfer apparatus information 51 includes information acquired by the control apparatus 20 from a transfer apparatus 10 of a target of management of the control apparatus 20 itself and statistical information acquired from the different control apparatus 20 in the system. In the transfer apparatus information 51 used in the sixth embodiment, information of a control apparatus 20 by which each transfer apparatus 10 is managed is recorded in association with the data path ID of the transfer apparatus 10. The transfer apparatus information 51 used in the sixth embodiment further includes a data path ID, an address, a TCP port number, port speed information, and the number of transmission bytes transmitted in a collection period.

A table T11 is a table indicative of the CPU use rate of each control apparatus 20. The control apparatus 20a and the control apparatus 20b notify each other of statistical information and besides of the CPU use rate of the control apparatus 20 itself. In the example of the table T11, the CPU use rate of the control apparatus 20a is 80%, and the CPU use rate of the control apparatus 20b is 20%.

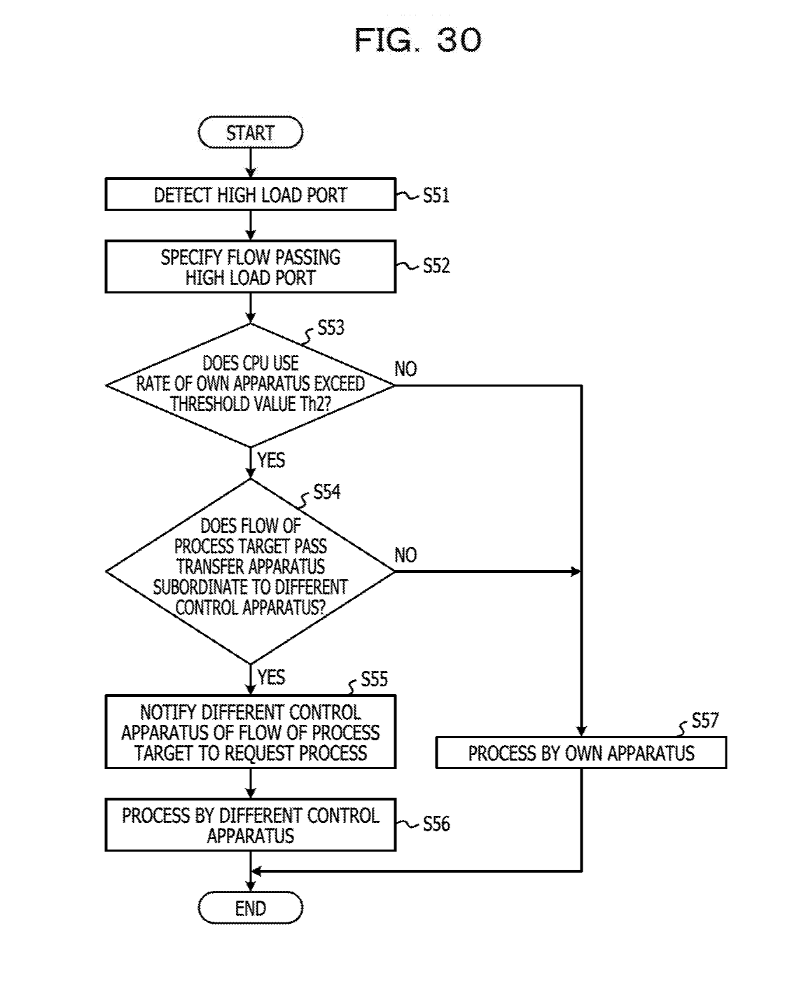

FIG. 30 is a flow chart illustrating an example of process performed in the sixth embodiment. In the following, an example of process performed in the sixth embodiment is described taking a case in which the use rate of the port 3 of the transfer apparatus 10c in FIG. 28 exceeds a threshold value as an example. In the following description, in order to facilitate understandings regarding by which one of the control apparatus 20 a process is to be performed, an alphabetical letter at the tail end of a reference numeral of the control apparatus 20 is added to the reference numeral. For example, the monitoring unit 31a signifies the monitoring unit 31 in the control apparatus 20a, and the monitoring unit 31b signifies the monitoring unit 31 in the control apparatus 20b.

The statistical information acquisition unit 41a of the control apparatus 20a calculates the use rate of the respective ports using statistical information obtained from a transfer apparatus 10 of a control target of the control apparatus 20a. The monitoring unit 31a compares results of the calculation by the statistical information acquisition unit 41a with the control threshold value 53. The monitoring unit 31a detects any port whose use rate exceeds the control threshold value 53 as a high load port (step S51). The flow selection unit 32a specifies flows which pass the high load port (step S52). Further, the flow selection unit 32a selects a flow whose transfer rate is to be decreased and determines a flow of a control target. The determination process for a flow of a control target by the flow selection unit 32a is similar to the determination process for any of the first to fifth embodiments. Here, it is assumed that the flow Flow1 is selected as a flow whose transfer rate is to be decreased and the flow Ac1 is determined as a flow of a control target.

The generation unit 42a decides whether the CPU use rate of the control apparatus 20a exceeds a threshold value Th2 (step S53). Here, it is assumed that the threshold value Th2 is 70%. In this case, since the CPU use rate in the control apparatus 20a is 80%, the CPU use rate in the control apparatus 20a exceeds the threshold value Th2. When the CPU use rate of the control apparatus 20a exceeds the threshold value in this manner, the generation unit 42a decides whether the flow of the control target passes a transfer apparatus 10 controlled by the different control apparatus 20 (Yes at step S53, and step S54). If the flow of the control target passes the transfer apparatus 10 controlled by the different control apparatus 20, the control apparatus 20a notifies the different control apparatus 20 of the flow of the control target to request for rate control (Yes at step S54, and step S55). In the example of FIG. 28, the flow Ac1 that is the flow of the control target passes the transfer apparatus 10a. Further, from the transfer apparatus information 51 in FIG. 29, the generation unit 42a recognizes that the transfer apparatus 10a is controlled by the control apparatus 20b. Consequently, the generation unit 42a notifies the control apparatus 20b of the flow Ac1 as a flow of a control target and requests the control apparatus 20b for rate control. Consequently, the control apparatus 20b performs rate control in accordance with the request from the control apparatus 20a (step S56).

On the other hand, if the CPU use rate of the control apparatus 20a does not exceed the threshold value Th2, the generation unit 42a determines that the control apparatus 20a is to perform a rate process (No at step S53). Also when the flow of the control target does not pass the transfer apparatus 10 being controlled by the different control apparatus 20, the generation unit 42a determines that the control apparatus 20a is to perform a rate process (No at step S54). If a negative decision is made at both of steps S53 and S54, rate control is performed by the control apparatus 20a (step S57). The process by the control apparatus 20a in this case is similar to the process in the first to fifth embodiments.

In this manner, if the sixth embodiment is used, in a system that includes a plurality of control apparatus 20, rate control is performed by the control apparatus 20 to which the process load is comparatively low. Therefore, load dispersion between or among a plurality of control apparatus 20 may be anticipated.

### Seventh Embodiment

A seventh embodiment is directed to an example in which the transmission rate of a flow for which a connectionless protocol is used is adjusted by rate control. It is to be noted that, in the following description, it is assumed that a host on the transmission side adjusts the transmission rate through notification of reception quality from a host on the reception side to the host on the transmission side by an application or the like that is used together with a connectionless protocol. For example, also where a combination of such a protocol as a real-time transport protocol (RTP), a real-time transport control protocol (RTCP), or a real-time transport streaming protocol (RTSP) and user datagram protocol (UDP) is used, the seventh embodiment may be applied. Although the following description is directed to a case in which the UDP is used as an example of a connectionless protocol, the connectionless protocol is not limited to the UDP.

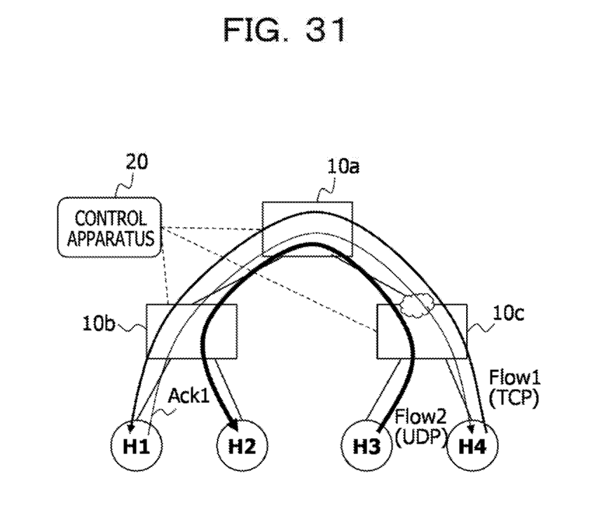

FIG. 31 is a view illustrating an example of a communication process performed in the seventh embodiment. A flow Flow1 is a flow of a TCP packet to be directed in a direction toward the host H1 from the host H4. The flow Flow2 is a flow of a packet to be transmitted from the host H3 toward the host H2, and UDP is used for the flow Flow2. Further, the flow Ack1 is a flow of an Ack packet of the flow Flow1 and is transmitted from the host H1 to the host H4. It is assumed that, when communication illustrated in FIG. 31 is being performed, the control apparatus 20 acquires statistical information from each transfer apparatus 10.

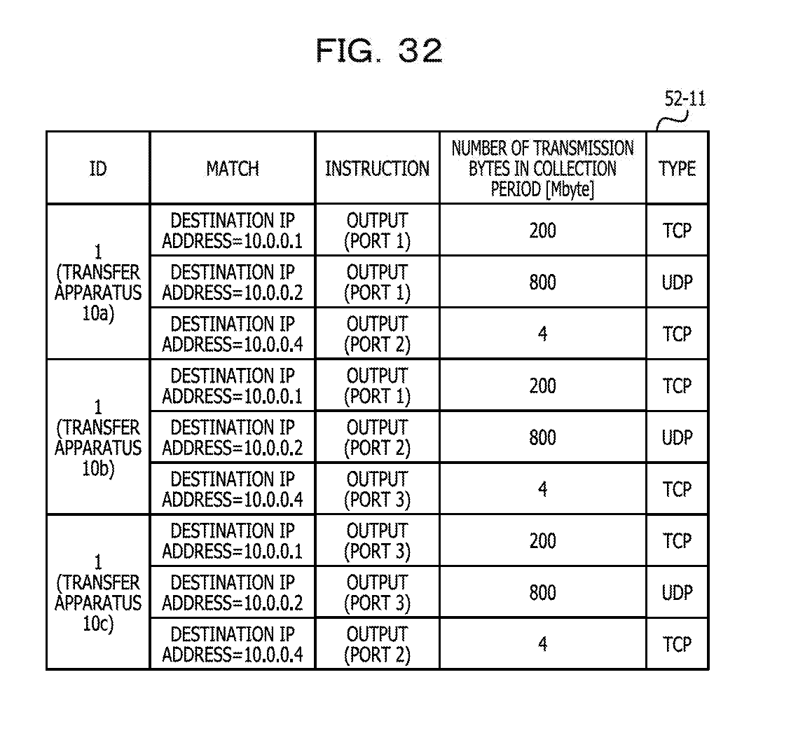

FIG. 32 is a view illustrating an example of a flow table 52 (52-11). The flow table 52-11 in FIG. 32 is generated from statistical information collected in the example of FIG. 31. In the example of the flow table 52-11, the information of the flow Flow1 is registered as information of a flow whose Match condition is the destination IP address=10.0.0.1. The information of the flow Flow2 is registered as information of a flow whose Match condition is the destination IP address=10.0.0.2, and the information of a flow Ack1 is registered as information of a flow whose Match condition is the destination IP address=10.0.0.4. Although, in the flow table 52 in FIG. 32, the destination IP address is designated as the Match condition, also in the seventh embodiment, a combination of a transmission source IP address and a destination IP address may be used as the Match condition similarly as in the second to sixth embodiments. The Instruction is a process rule that is applied to a flow of the Match condition in the entry by a transfer apparatus 10 associated with the entry.

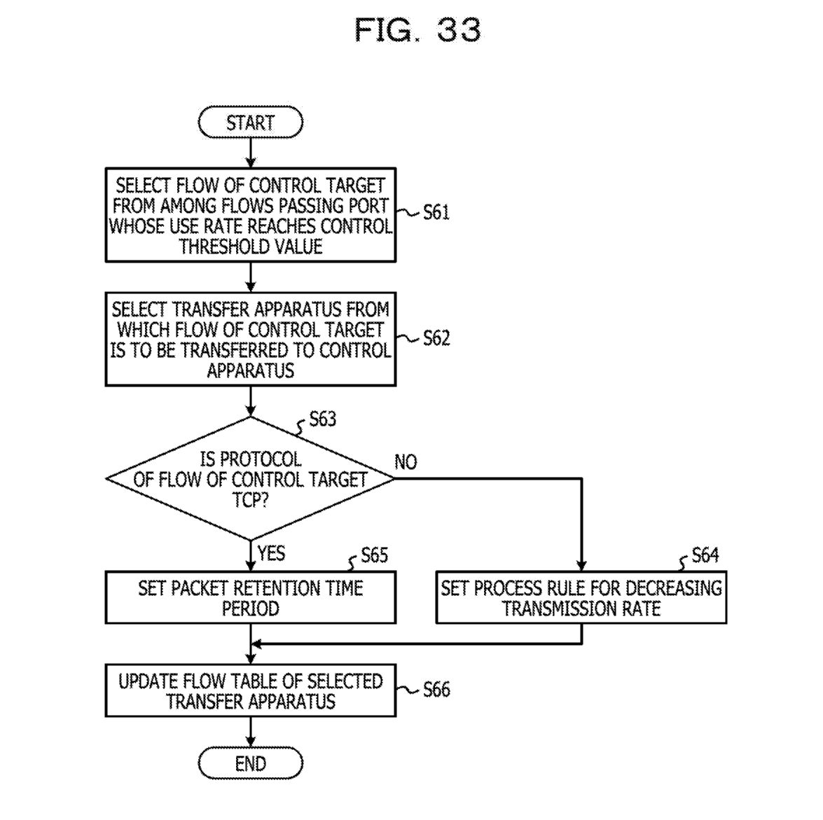

FIG. 33 is a flow chart illustrating an example of process performed in the seventh embodiment. It is assumed that the control apparatus 20 according to the seventh embodiment includes a control method selection unit 34. It is to be noted that FIG. 33 illustrates an example where TCP or UDP is used as a protocol. It is to be noted that FIG. 33 illustrates an example. The order of processes is changed in accordance with actual incorporation, for example, such that the process at step S62 is performed after a decision at step S63.

The flow selection unit 32 selects a flow of a control target from among flows that pass a port whose use rate reaches the control threshold value 53 (step S61). The apparatus selection unit 33 selects, from among the transfer apparatus 10 through which the flow of the control target passes, a transfer apparatus 10 from which the flow of the control target is to be transferred to the control apparatus 20 (step S62). The control method selection unit 34 decides whether the protocol of the flow of the control target is the TCP (step S63). If the protocol of the flow of the control target is not the TCP, the protocol of the flow of the control target is the UDP (No at step S63).

Since the UDP is a protocol for a connectionless packet, the control method selection unit 34 determines a process rule for decreasing the transmission rate in response to actual incorporation of a protocol or an application used in combination with the UDP. For example, it is assumed that the system is configured such that reception quality is reported from a host on the reception side to a host on the transmission side by the RTCP and adjustment of the transmission rate is performed on the transmission side. As the reception quality of which the host on the reception side notifies the host on the transmission side, a delay, jitters (delay fluctuation), a discarding situation and so forth are available. In this case, an application that operates in the host on the transmission side adjusts the transmission rate using the reception quality notified of from the host on the reception side. Here, the adjustment method of the transmission rate on the transmission side relies upon actual incorporation of the application. Accordingly, an application that decreases the transmission rate when a delay on the reception side becomes great in a network system or an application that decreases the transmission rate when discarding of packets becomes great may be used.

The control method selection unit 34 stores in advance a process when a flow using the UDP is selected as a control target in response to a type of an application of the host on the transmission side. For example, in a system in which an application that decreases the transmission rate when the displacement of the delay becomes great on the reception side is used, the control method selection unit 34 stores, as a process, to vary the time period for retaining a packet of the flow of the control target for each packet. On the other hand, in the case of another system in which an application that decreases the transmission rate when the amount of discarded packets becomes great is used, the control method selection unit 34 may store, as control contents, to discard part of packets of the flow of the control target. It is to be noted that, since the processes mentioned are performed for a flow for which the UDP is used, even if discarding of packets occurs, a sudden decrease of the transmission rate as in a case in which the TCP is used does not occur. If the control method selection unit 34 decides that the flow of the control target is not of the TCP, the control method selection unit 34 sets a process rule for decreasing the transmission rate using the information stored in advance as a process for the flow of the control target (step S64).

On the other hand, if the control method selection unit 34 decides that the flow of the control target is of the TCP, the control method selection unit 34 selects a delay for a packet as the control method and notifies the generation unit 42 of the selection. Therefore, similarly as in the process described hereinabove in connection with the first to sixth embodiments, a retention time period for the packet is set (Yes at step S63, and step S65). After the process at step S64 or S65, the generation unit 42 updates the flow table for the transfer apparatus 10 selected as the control target (step S66).

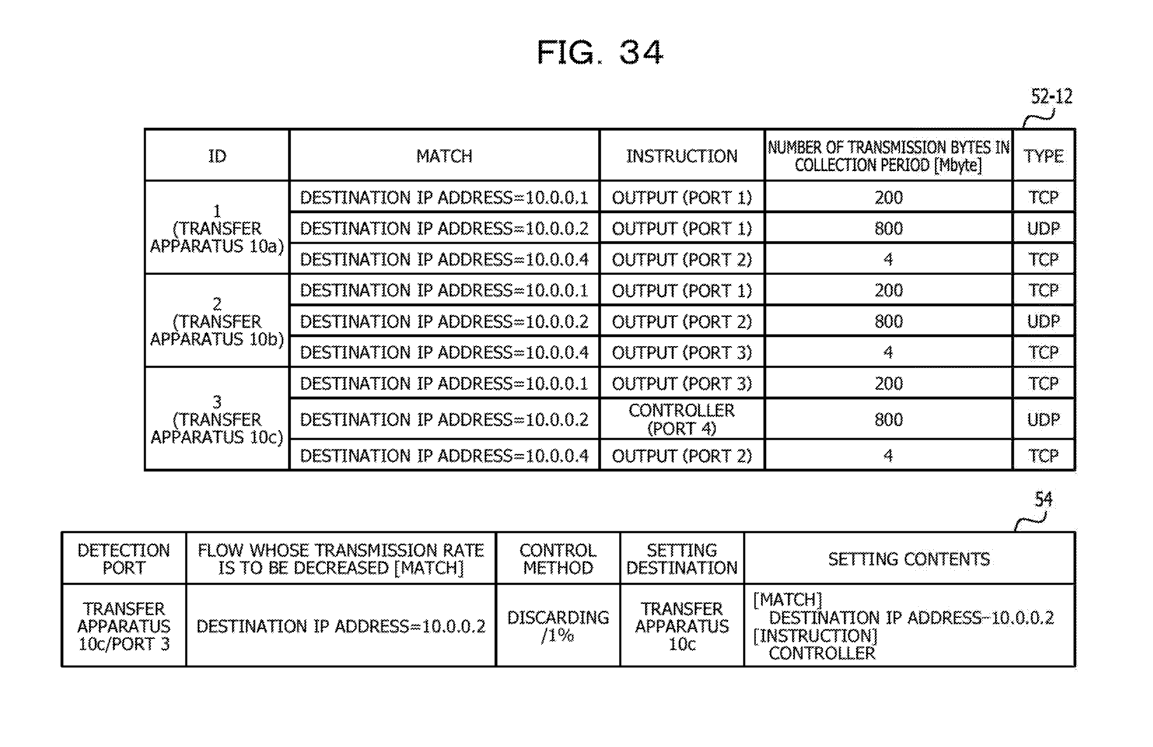

FIG. 34 is a view illustrating an example of an updating process for the flow table 52. The flow table 52-12 is an example of the flow table 52 that is obtained when the flow Flow2 in FIG. 31 is selected as the flow of the control target. It is assumed that the flow Flow2 is selected as a flow of a control target and the transfer apparatus 10c is selected as a transfer apparatus 10 from which the flow of the control target is to be transferred to the control apparatus 20. In this case, the generation unit 42 changes the flow table 52-11 (FIG. 32) to the flow table 52-12 such that a packet of the flow Flow2 may be transferred from the transfer apparatus 10c to the control apparatus 20.

On the other hand, the control method selection unit 34 records contents determined as a process to be performed for the flow Flow2 into the control target information 54. Here, since the process for the flow Flow2 by the transfer apparatus 10c is to be changed, the setting destination is the transfer apparatus 10c and the setting contents are to transfer a flow whose destination IP address=10.0.0.2 to the control apparatus 20 (Instruction=CONTROLLER). Further, it is assumed that the control method selection unit 34 determines that the control apparatus 20 discards 1% of packets of the flow Flow2 transferred from the transfer apparatus 10c. Consequently, it is recorded that, as the control method, discarding of a packet is to be performed and that the discarding rate is set to 1% as depicted in FIG. 34. It is to be noted that, in the example of FIG. 34, also information of an apparatus that is in a high load state and information of a flow whose transmission rate is to be decreased are included in the control target information 54. In the example of FIG. 34, rate control is started in response to that the use rate at the port 3 of the transfer apparatus 10c exceeds the control threshold value 53, and a flow whose transmission rate is to be decreased is a flow of the destination IP address=10.0.0.2.

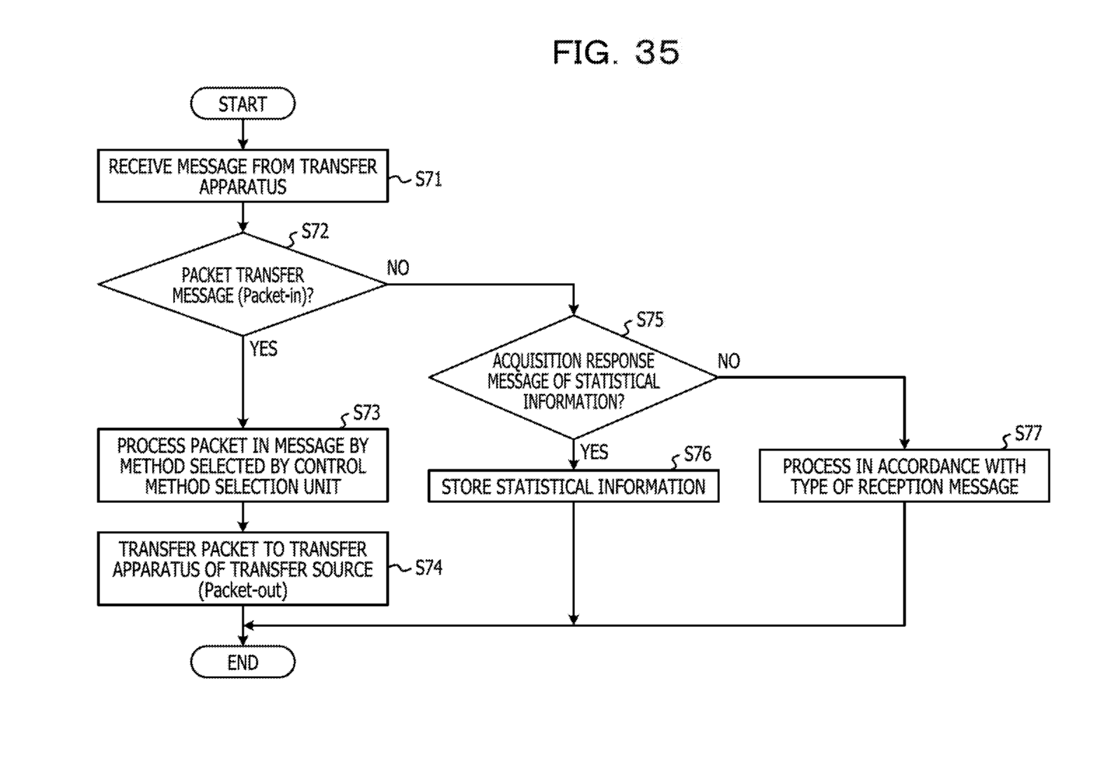

FIG. 35 is a flow chart illustrating an example of process performed by the control apparatus 20. The reception unit 23 of the control apparatus 20 receives a message from a transfer apparatus 10 (step S71). The statistical information acquisition unit 41 decides whether the message is a packet transfer message (step S72). If the received message is a packet transfer message, the statistical information acquisition unit 41 refers to the control target information 54 to specify a method selected by the control method selection unit 34 (Yes at step S72).

The statistical information acquisition unit 41 processes a packet in the packet transfer message by the method selected by the control method selection unit 34. For example, if discarding of a packet is set, the statistical information acquisition unit 41 discards, from among packets transferred by the packet transferred message, the number of packets corresponding to a discarding rate recorded in the control target information 54 and outputs the remaining packets to the transfer processing unit 43. It is to be noted that, at this time, the statistical information acquisition unit 41 notifies the transfer processing unit 43 also of information of the transmission source of the packet transfer message as the transfer destination of the remaining packets. On the other hand, if it is selected by the control method selection unit 34 that a packet is to be retained such that the jitters fluctuate, the statistical information acquisition unit 41 outputs the packet transfer message to the buffer 56 together with a retention time period determined at random. The buffer 56 retains the packet transfer message inputted from the statistical information acquisition unit 41 over a period of time designated from the statistical information acquisition unit 41 and thereafter outputs the packet transfer message to the transfer processing unit 43. It is to be noted that the method selected by the control method selection unit 34 is a retention process and the retention time period does not vary between packets, the packet transfer message is retained for a given period of time in the buffer 56 and then outputted to the transfer processing unit 43 similarly as in the first to sixth embodiments.

Processes at steps S74 to S77 are similar to the processes described hereinabove in connection with steps S24 to S27 in FIG. 13. It is to be noted that, where part of packets are discarded, the process at step S74 is performed for the remaining packets that are not discarded.

In this manner, if the seventh embodiment is used, the transmission rate may be decreased in regard to a connectionless flow. Therefore, when the transmission rate of a flow of a connectionless protocol is higher than the transmission rate of a flow of a connection type protocol, for example, as illustrated in FIGS. 31 and 32, the load to a port may be reduced efficiently using the seventh embodiment.

### Eighth Embodiment

An eighth embodiment is directed to an example of process when the load to the control apparatus 20 is further reduced using a delay apparatus 120.

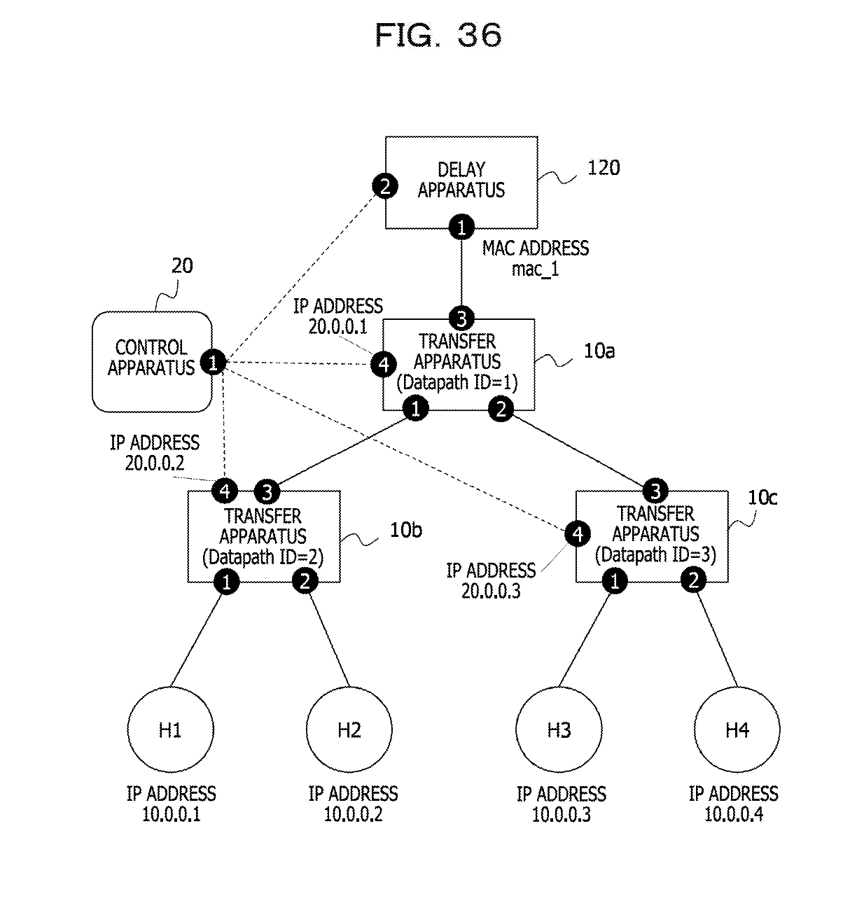

FIG. 36 is a view depicting an example of a system to which the eighth embodiment is applied. In the system in which the eighth embodiment is used, a delay apparatus 120 is coupled to the transfer apparatus 10a. The delay apparatus 120 may be a packet processing apparatus for exclusive use having a function for retaining a received packet for a given period of time and then transferring the packet. Alternatively, the delay apparatus 120 may be implemented using a packet emulator function by software provided by an operating system (OS) installed in a server for universal use. As the packet emulator function, for example, netem by Linux (registered trademark) may be used. Further, the delay apparatus 120 may be implemented by a virtual machine that operates by a hypervisor on a server for universal use. The virtual machine that operates as the delay apparatus 120 may be a virtual machine for which deployment or validation is performed dynamically on a server for universal use by network function virtualization (NFV).

The transfer apparatus 10a is coupled to a transfer apparatus 10b, another transfer apparatus 10c, and a control apparatus 20 in addition to the delay apparatus 120. The delay apparatus 120 is coupled to the control apparatus 20 in addition to the transfer apparatus 10a. The transfer apparatus 10b is coupled to a host H1, another host H2, the transfer apparatus 10a, and the control apparatus 20. The transfer apparatus 10c is coupled to a host H3, another host H4, the transfer apparatus 10a, and the control apparatus 20. In FIG. 36, a port of the transfer apparatus 10 is indicated by a solid round mark, and a port number is indicated in the dark round mark. It is assumed that a media access control (MAC) address allocated to the delay apparatus 120 is mac_1. Data path IDs allocated to the transfer apparatus 10a to 10c and IP addresses allocated to the hosts H1 to H4 are similar to the data path ISs and the IP addresses in FIG. 4. Also in FIG. 36, a link used for transmission and reception of a control packet is indicated by a broken line, and a link used for transmission and reception of a data packet or an Ack packet is indicated by a solid line.

In the eighth embodiment, if the use rate at any port of the transfer apparatus 10 reaches the control threshold value 53, the control apparatus 20 selects a flow of a control target from among flows that pass the transfer apparatus 10a coupled to the delay apparatus 120. The generation unit 42 in the control apparatus 20 requests the transfer apparatus 10a to transfer a packet of the flow of the control target to the delay apparatus 120. Further, the generation unit 42 sets also a process rule for causing the transfer apparatus 10a to output a packet received from the delay apparatus 120 by the transfer apparatus 10a toward the destination of the packet to the transfer apparatus 10a.

For example, it is assumed that, in the system in FIG. 36, communication by four flows of Flow1, Flow2, Ac1, and Ac2 is performed. It is assumed that the flow Flow1 is a flow transmitted from the host H4 and coming to the host H1 through the transfer apparatus 10c, the transfer apparatus 10a, and the transfer apparatus 10b. It is assumed that the flow Ac1 is a flow of an Ack packet of a packet transmitted and received in the flow Flow1. It is assumed that the flow Flow2 is a flow that is transmitted from the host H3 and comes to the host H2 through the transfer apparatus 10c, the transfer apparatus 10a, and the transfer apparatus 10b. It is assumed that the flow Ac2 is a flow of an Ack packet of a packet transmitted and received in the flow Flow2. It is assumed that, in this state, the use rate at the port 3 of the transfer apparatus 10c exceeds the control threshold value 53.

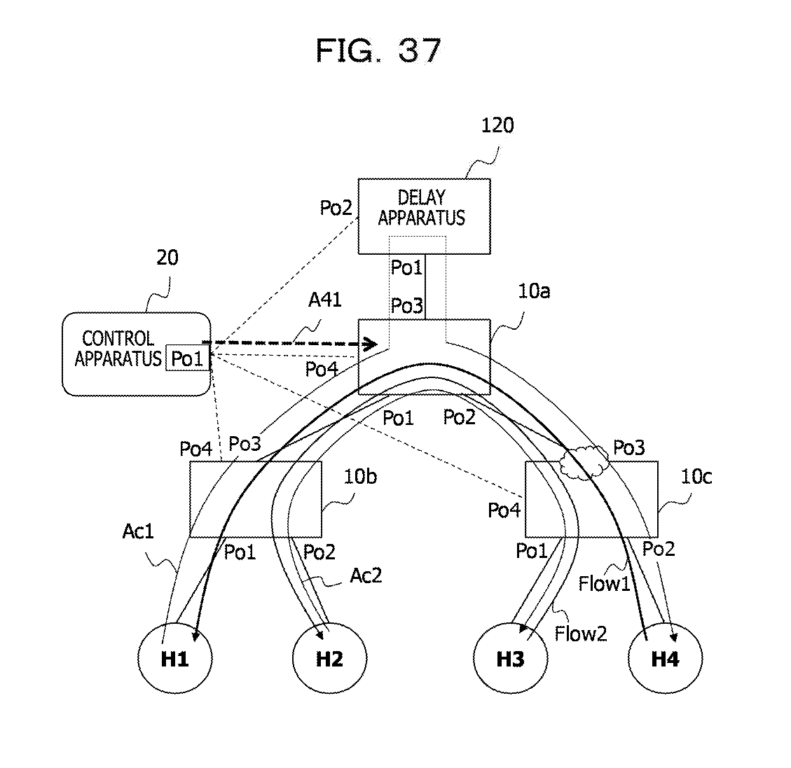

FIG. 37 is a view illustrating an example of a communication process performed in the eighth embodiment. In the following, an example of rate control is described with reference to FIG. 37. The monitoring unit 31 in the control apparatus 20 notifies the flow selection unit 32 and the apparatus selection unit 33 that the use rate exceeds the control threshold value 53. The apparatus selection unit 33 specifies a transfer apparatus 10 coupled to the delay apparatus 120 using the topology information 55 or the like and notifies the flow selection unit 32 of the specified transfer apparatus 10. The flow selection unit 32 selects a flow that passes the transfer apparatus 10 coupled to the delay apparatus 120 from among flows that may be used for adjustment of the speed of a flow communicated through the port whose use rate exceeds the control threshold value 53 as a flow of a control target. Here, it is assumed that the flow Ac1 is selected as the flow of the control target. The flow selection unit 32 notifies the generation unit 42 of the information of the flow of the control target and the information of the transfer apparatus 10 (transfer apparatus 10a) coupled to the delay apparatus 120.

In the transfer apparatus 10a, the generation unit 42 generates a FlowMod message for setting that a packet in the flow of the flow Ac1 is to be outputted to the delay apparatus 120 and that a packet received from the delay apparatus 120 and destined for the host H4 is to be outputted from the port 2. It is to be noted that, since the transfer apparatus 10c is coupled to the port 2 of the transfer apparatus 10a, if a packet of the flow Ac1 is outputted from the port 2 of the transfer apparatus 10a, the packet is transferred toward the destination. Further, in the following description, it is assumed that, when a packet received from the delay apparatus 120 and destined for the host H4 is to be specified, the input port of the packet to the transfer apparatus 10a is the port 1 (Po1) and besides the Match condition of the destination IP address=10.0.0.4 is used. The generation unit 42 transmits the generated FlowMod message to the transfer apparatus 10a through the transmission unit 22 (arrow mark A41). The generation unit 42 updates the information in the transfer apparatus 10a in the flow table 52 using the information to be notified of by the FlowMod message to the transfer apparatus 10a.

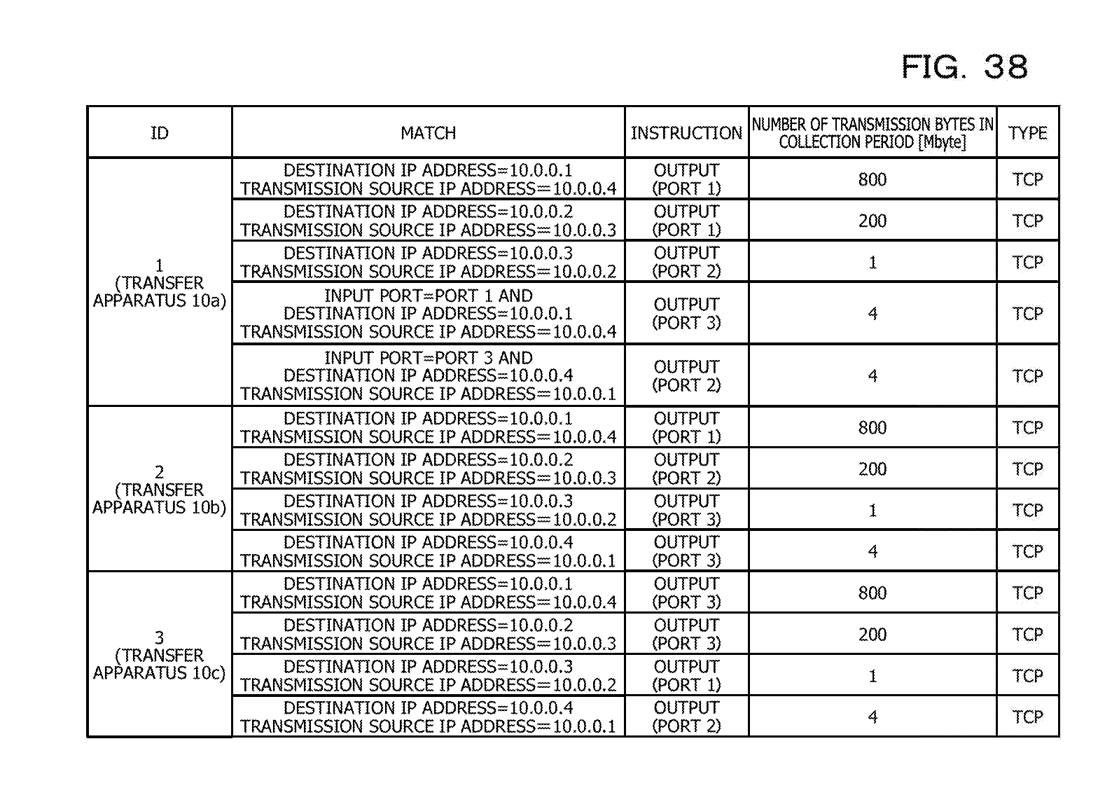

FIG. 38 is a view illustrating an example of the flow table 52 updated by the generation unit 42. In FIG. 38, it is recorded that, in a Match condition used in the transfer apparatus 10a, a flow with regard to which the input port is the port 1, the transmission source IP address=10.0.0.1 and the destination IP address=10.0.0.4 is to be outputted from the port 3 coupled to the delay apparatus 120. Further, it is recorded that a flow with regard to which the input port is the port 3, the transmission source IP address=10.0.0.1 and the destination IP address=10.0.0.4 is to be outputted from the port 2.

The transfer apparatus 10a receiving a FlowMod message transmitted along an arrow mark A41 changes the process for the packet in accordance with the FlowMod message. Accordingly, the flow table of the transfer apparatus 10a is similar to the information associated with the transfer apparatus 10a in the flow table 52 depicted in FIG. 38. Therefore, after the changing process, as depicted in FIG. 37, a packet in the flow Ac1 is transmitted from the host H1 and arrives at the transfer apparatus 10a through the transfer apparatus 10b, whereafter the packet in the flow Ac1 is transferred from the transfer apparatus 10a to the delay apparatus 120. Further, the packet in the flow Ac1 is retained over a given period of time in the delay apparatus 120 and then is transferred to the transfer apparatus 10a. The transfer apparatus 10a receiving the packet of the flow Ac1 from the delay apparatus 120 outputs the packet of the flow Ac1 from the port 2. Therefore, the packet of the flow Ac1 is transferred from the transfer apparatus 10a to the transfer apparatus 10c and arrives at the host H4. For example, the packet of the flow Ac1 is transferred along a route similar to the route indicated by an arrow mark denoted by Ac1 in FIG. 37.

Therefore, the period of time for the packet in the flow Ac1 to reach the host H4 increases by the sum of a period of time in which the packet is retained in the delay apparatus 120 and a period of time over which the packet reciprocates between the transfer apparatus 10a and the delay apparatus 120 in comparison with before the rate control is performed. Therefore, the host H4 of the transmission source of the flow Flow1 decreases the transmission rate for the flow Flow1, and as a result, the use rate of the port 3 of the transfer apparatus 10c decreases.

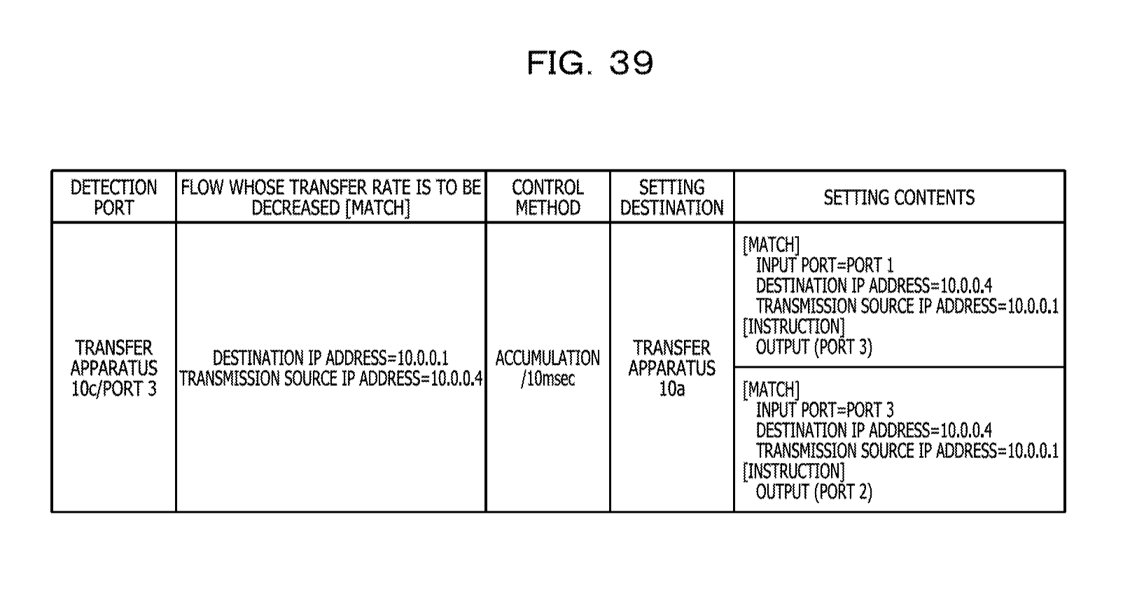

FIG. 39 is a view illustrating an example of control target information 54. Where the processes described hereinabove with reference to FIGS. 36 and 37 are performed, the control target information 54 is updated by the generation unit 42. The generation unit 42 records contents determined as a process to be performed for the flow Ac1 into the control target information 54. Here, since the process by the transfer apparatus 10a for the flow Ac1 is changed, the setting destination is the transfer apparatus 10a and the setting contents are to output a flow whose transmission source IP address=10.0.0.1 and destination IP address=10.0.0.4 from the port 3. Further, where the retention time period of each packet by the delay apparatus 120 is 10 milliseconds, a control method is recorded as depicted in FIG. 39. Further, in the example of FIG. 39, also information of an apparatus that is in a high load state or information of a flow whose transmission rate is to be decreased is included in the control target information 54. In the example of FIG. 39, rate control is started in response to the event that the use rate of the port 3 of the transfer apparatus 10c exceeds the control threshold value 53, and the flow whose transmission rate is to be decreased is a flow whose destination IP address=10.0.0.1 and transmission source IP address=10.0.0.4.

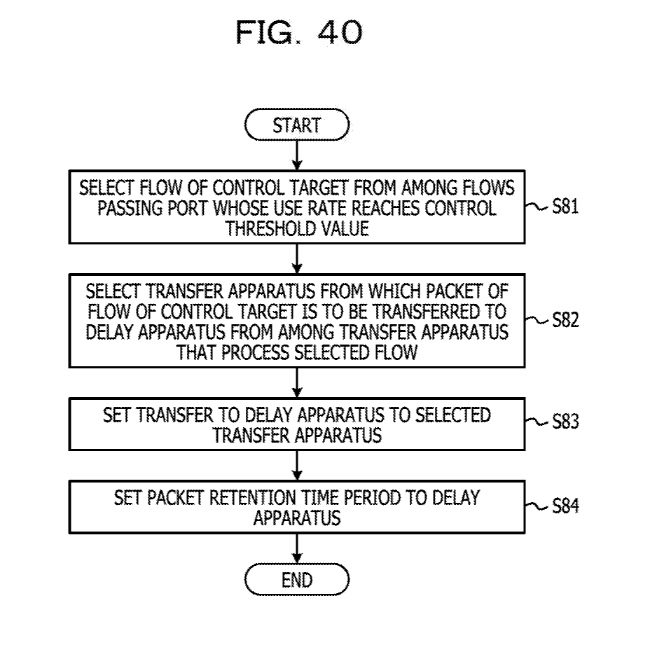

FIG. 40 is a flow chart illustrating an example of a setting process in the eighth embodiment. The flow selection unit 32 selects a flow of a control target from among flows that pass a port whose use rate reaches the control threshold value 53 (step S81). The apparatus selection unit 33 selects, from among transfer apparatus 10 that process the selected flow, the transfer apparatus 10 from which a packet of the flow of the control target is to be transferred to the delay apparatus 120 (step S82). The generation unit 42 transmits a FlowMod message to perform setting to the selected transfer apparatus 10 for transferring the flow of the control target to the delay apparatus 120 (step S83). Further, the generation unit 42 sets a period of time (packet retention time period) for which a packet transferred to the control apparatus 20 is to be retained by the delay apparatus 120 (step S84).

In this manner, if the eighth embodiment is used, retention of a packet to be delayed is performed by the delay apparatus 120 in place of the control apparatus 20. Rate control may be performed while it is suppressed that a process load is applied to the control apparatus 20.

<Others>

It is to be noted that the embodiments are not limited to those described above and may be modified in various manners. Several examples of the modification are described below.

For example, the control plane network may be coupled by an L2 switch for universal use or the like. The control apparatus 20 may read in static information retained in the storage apparatus 106 and statically set the flow table 52 or may dynamically set the flow table 52 by a program for determining the flow table 52.

While, in the foregoing description, the flow table 52 includes information of ports or information of flows collected from the transfer apparatus 10 by the control apparatus 20, the information may be stored in a table different from the table of the information of flows.

Also in the eighth embodiment, a flow whose data amount is small may be selected as a control target similarly as in the second embodiment or the third embodiment. Further, also in the eighth embodiment, a flow that passes a comparatively large number of transfer apparatus 10 may be selected preferentially as a control target similarly as in the fourth embodiment.

In any embodiment, the period of time for which the control apparatus 20 retains a packet is set in accordance with actual incorporation. The retention time period by the control apparatus 20 may be substantially equal among all packets or may change among different packets. Alternatively, the retention time period may be set such that the retention time period increases for a packet in a flow whose transmission rate is higher. Alternatively, the retention time period may be set so as to vary with respect to time such that it increases as the elapsed time period after the rate control is started increases.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control apparatus configured to control a plurality of data transfer apparatus including a first data transfer apparatus including a first port, the control apparatus comprising:
a memory; and
a processor coupled to the memory and configured to:
detect that a first transmission rate of first data transmitted using the first port of the first data transfer apparatus is equal to or higher than a first value,
request, when it is detected that the first transmission rate is equal to or higher than the first value, a second data transfer apparatus included in the plurality of data transfer apparatus to change a destination of a first packet from a first information processing apparatus to a data buffer, the first packet being to be transmitted using the first port,
cause, after the first packet transmitted from the second data transfer apparatus is stored in the data buffer for a first period, the data buffer to transmit the first packet to the second data transfer apparatus, and
request the second data transfer apparatus to change the destination of the first packet from the data buffer to the first information processing apparatus, the first packet being transmitted from the data buffer to the second data transfer apparatus.

2. The control apparatus according to claim 1, wherein
the data buffer is included in the control apparatus.

3. The control apparatus according to claim 1, wherein,
after the control apparatus requests the second data transfer apparatus to change the destination of the first packet from the data buffer to the first information processing apparatus, the second data transfer apparatus transmits the first packet to the first information processing apparatus using the first port.

4. The control apparatus according to claim 1, wherein,
after the control apparatus requests the second data transfer apparatus to change the destination of the first packet from the first information processing apparatus to the data buffer, the second data transfer apparatus transmits the first packet to the data buffer, and the data buffer stores the first packet transmitted from the second data transfer apparatus.

5. The control apparatus according to claim 3, wherein
the first packet is included in a first flow that includes a plurality of packets to be transmitted from the second data transfer apparatus to the first information processing apparatus.

6. The control apparatus according to claim 5, wherein
the processor is further configured to:
detect, after it is detected that the first transmission rate is equal to or higher than the first value, that the first transmission rate becomes lower than the first value, and
request, when it is detected that the first transmission rate becomes lower than the first value, the second data transfer apparatus not to change a destination of a second packet included in the first flow from the first information processing apparatus to the data buffer.

7. The control apparatus according to claim 5, wherein
the processor is further configured to:
compare a second transmission rate of second data and the first transmission rate, the second data being transmitted using the first port as a second flow that includes a plurality of packets, and
request, when the first transmission rate is lower than the second transmission rate, the second data transfer apparatus to change the destination of the first packet.

8. The control apparatus according to claim 5, wherein
the first data transfer apparatus transmits a plurality of packets using the first port to a second information processing apparatus, and
the processor is configured to:
compare a first number of data transfer apparatus provided between the first information processing apparatus and a source information processing apparatus of the first information processing apparatus and a second number of data transfer apparatus provided between the second information processing apparatus and a source information processing apparatus of the second information processing apparatus, and
request, when the first number is larger than the second number, the second data transfer apparatus to change the destination of the first packet from the first information processing apparatus to the data buffer.

9. The control apparatus according to claim 1, wherein
the processor is further configured to:
compare a first communication amount between the second data transfer apparatus and the control apparatus with a second communication amount between a third data transfer apparatus and the control apparatus, and
request, when the second communication amount is smaller than the first communication amount, the third data transfer apparatus to change a destination of the first packet from the first information processing apparatus to the data buffer.

10. The control apparatus according to claim 1, wherein
the second data transfer apparatus is different from the first data transfer apparatus.

11. The control apparatus according to claim 9, wherein
the third data transfer apparatus is different from the first data transfer apparatus.

12. A data transmitting system comprising:
a plurality of data transfer apparatus including a first data transfer apparatus including a first port;
a data buffer; and
a control apparatus including a memory and a processor coupled to the memory and configured to:
detect that a first transmission rate of first data transmitted using the first port of the first data transfer apparatus is equal to or higher than a first value,
request, when it is detected that the first transmission rate is equal to or higher than the first value, a second data transfer apparatus included in the plurality of data transfer apparatus to change a destination of a first packet from a first information processing apparatus to the data buffer, the first packet being to be transmitted using the first port,
cause, after the first packet transmitted from the second data transfer apparatus is stored in the data buffer for a first period, the data buffer to transmit the first packet to the first data transfer apparatus, and
request the second data transfer apparatus to change the destination of the first packet from the data buffer to the first information processing apparatus, the first packet being transmitted from the data buffer to the second data transfer apparatus.

13. The data transmitting system according to claim 12, wherein
the data buffer is included in the control apparatus.

14. The data transmitting system according to claim 12, wherein,
after the control apparatus requests the second data transfer apparatus to change the destination of the first packet from the data buffer to the first information processing apparatus, the first data transfer apparatus transmits the first packet to the first information processing apparatus using the first port.

15. The data transmitting system according to claim 12, wherein,
after the control apparatus requests the second data transfer apparatus to change the destination of the first packet from the first information processing apparatus to the data buffer, the second data transfer apparatus transmits the first packet to the data buffer, and the data buffer stores the first packet transmitted from the second data transfer apparatus.

16. The data transmitting system according to claim 14, wherein
the first packet is included in a first flow that includes a plurality of packets to be transmitted from the second data transfer apparatus to the first information processing apparatus.

17. The data transmitting system according to claim 16, wherein
the processor is further configured to:
detect, after it is detected that the first transmission rate is equal to or higher than the first value, that the first transmission rate becomes lower than the first value, and
request, when it is detected that the first transmission rate becomes lower than the first value, the second data transfer apparatus not to change a destination of a second packet included in the first flow from the first information processing apparatus to the data buffer.

18. The data transmitting system according to claim 16, wherein
the processor is further configured to:
compare a second transmission rate of second data and the first transmission rate, the second data being transmitted using the first port as a second flow that includes a plurality of packets, and
request, when the first transmission rate is lower than the second transmission rate, the second data transfer apparatus to change the destination of the first packet.

19. The data transmitting system according to claim 16, wherein
the first data transfer apparatus transmits a plurality of packets using the first port to a second information processing apparatus, and
the processor is configured to:
compare a first number of data transfer apparatus provided between the first information processing apparatus and a source information processing apparatus of the first information processing apparatus and a second number of data transfer apparatus provided between the second information processing apparatus and a source information processing apparatus of the second information processing apparatus, and
request, when the first number is larger than the second number, the second data transfer apparatus to change the destination of the first packet from the first information processing apparatus to the data buffer.

20. The data transmitting system according to claim 12, wherein
the processor is further configured to:
compare a first communication amount between the second data transfer apparatus and the control apparatus with a second communication amount between a third data transfer apparatus and the control apparatus, and
request, when the second communication amount is smaller than the first communication amount, the third data transfer apparatus to change a destination of the first packet from the first information processing apparatus to the data buffer.

21. The control apparatus according to claim 12, wherein
the second data transfer apparatus is different from the first data transfer apparatus.

22. A method of data transmitting using a first data transfer apparatus including a first port, a data buffer and a control apparatus, the method comprising:
detecting, by the control apparatus, that a first transmission rate of first data transmitted using the first port of the first data transfer apparatus is equal to or higher than a first value;
requesting, by the control apparatus, when it is detected that the first transmission rate is equal to or higher than the first value, a second data transfer apparatus to change a destination of a first packet from a first information processing apparatus to the data buffer, the first packet being to be transmitted using the first port;
changing, by the second data transfer apparatus, the destination of the first packet from the first information processing apparatus to the data buffer;
transmitting, by the second data transfer apparatus, the first packet to the data buffer;
storing the first packet in the data buffer for a first period;
causing, by the control apparatus, after the first packet is stored in the data buffer for the first period, the data buffer to transmit the first packet to the second data transfer apparatus;
requesting the second data transfer apparatus to change the destination of the first packet from the data buffer to the first information processing apparatus, the first packet being transmitted from the data buffer to the second data transfer apparatus;
changing, by the second data transfer apparatus, the destination of the first packet from the data buffer to the first information processing apparatus; and
transmitting, by the second data transfer apparatus, the first packet to the first information processing apparatus.
